(19) United States
(12) Patent Application Publication
(10) Pub. No.: US 2025/0039733 A1
(43) Pub. Date: Jan. 30, 2025

(54) DATA TRANSMISSION METHOD AND APPARATUS, AND COMMUNICATION DEVICE

(71) Applicant: GUANGDONG OPPO MOBILE TELECOMMUNICATIONS CORP., LTD., Dongguan (CN)

(72) Inventors: Shukun WANG, Dongguan (CN); Zhe FU, Dongguan (CN); Cong SHI, Dongguan (CN)

(21) Appl. No.: 18/917,012

(22) Filed: Oct. 16, 2024

Related U.S. Application Data
(63) Continuation of application No. PCT/CN2022/088094, filed on Apr. 21, 2022.

(51) Int. Cl. H04W 28/02; H04W 8/24

(52) U.S. Cl. CPC H04W 28/0268; H04W 8/24

(57) ABSTRACT

A data transmission method includes: a PDCP layer receives a first SDAP PDU, which is sent by an SDAP layer, the first SDAP PDU being a downlink SDAP control PDU.

### CROSS-REFERENCE TO RELATED APPLICATION

This application is a continuation of International Application No. PCT/CN2022/088094 filed on Apr. 21, 2022, the disclosure of which is hereby incorporated by reference in its entirety.

### BACKGROUND

A Packet Data Unit (PDU) set is composed of one or more PDUs. For one PDU set representing one frame or one video slice, each PDU in the PDU set represents a data packet at an application layer. However, in a current mobile communication system, a radio air interface can only identify individual data packets (i.e. PDUs) when the data to be transmitted is processed, but cannot identify an association between PDUs, let alone an association between PDU sets or frames. As a result, these associations cannot be taken into account in a data transmission procedure, and data transmission efficiency cannot be guaranteed.

### SUMMARY

Embodiments of the present disclosure relate to the technical field of mobile communications, and in particular to, data transmission methods, data transmission devices, and a communication device.

Embodiments of the present disclosure provide data transmission methods and data transmission devices, a communication device, a chip, a computer-readable storage medium, a computer program product, and a computer program.

A data transmission method provided by the embodiment of the present disclosure includes the following operation. A Packet Data Convergence Protocol (PDCP) layer receives a first Service Data Adaptation Protocol (SDAP) Packet Data Unit (PDU) sent by a SDAP layer, where the first SDAP PDU is a downlink SDAP control PDU including at least one of following information: first information for indicating whether the first SDAP PDU is a data PDU or a control PDU; second information for indicating a Quality of Service (Qos) flow Identifier (ID) associated with the first SDAP PDU; third information for indicating a control PDU type to which the first SDAP PDU belongs; fourth information for indicating a frame type corresponding to a PDU set or a frame associated with the first SDAP PDU; fifth information for indicating a Qos attribute of the PDU set, the frame or a PDU associated with the first SDAP PDU; sixth information for indicating an ID of the PDU set or the frame associated with the first SDAP PDU; seventh information for indicating an ID of a Group of Pictures (GOP) to which the PDU set or the frame associated with the first SDAP PDU belongs; or eighth information for indicating IDs of at least part of PDUs in the PDU set associated with the first SDAP PDU.

A data transmission method provided by the embodiment of the present disclosure includes following operation. A terminal device receives a second SDAP PDU sent by a network device, the second SDAP PDU being a downlink SDAP data PDU, where the downlink SDAP data PDU in a first format includes first information for indicating whether the second SDAP PDU is a data PDU or a control PDU.

A data transmission device provided by the embodiment of the present disclosure includes a processor and a memory. The memory is configured to store computer-executable instructions, and the processor is configured to invoke and execute the computer-executable instructions stored in the memory to perform an operation of: receiving, by a Packet Data Convergence Protocol (PDCP) layer, a first Service Data Adaptation Protocol (SDAP) Packet Data Unit (PDU) sent by a SDAP layer, the first SDAP PDU being a downlink SDAP control PDU. The downlink SDAP control PDU includes at least one of following information: first information for indicating whether the first SDAP PDU is a data PDU or a control PDU; second information for indicating a Quality of Service (Qos) flow Identifier (ID) associated with the first SDAP PDU; third information for indicating a control PDU type to which the first SDAP PDU belongs; fourth information for indicating a frame type corresponding to a PDU set or a frame associated with the first SDAP PDU; fifth information for indicating a Qos attribute of the PDU set, the frame or a PDU associated with the first SDAP PDU; sixth information for indicating an ID of the PDU set or the frame associated with the first SDAP PDU; seventh information for indicating an ID of a Group of Pictures (GOP) to which the PDU set or the frame associated with the first SDAP PDU belongs; or eighth information for indicating IDs of at least part of PDUs in the PDU set associated with the first SDAP PDU

### BRIEF DESCRIPTION OF THE DRAWINGS

The drawings described herein are used to provide a further understanding of the application and form a part of the application. The schematic embodiments of the application and the description thereof are used to explain the application and do not constitute an improper limitation of the application. In the drawings:

FIG. 1 is a schematic diagram of an application scenario;

FIG. 2 is a diagram of a 5-th Generation (5G) network system architecture;

FIG. 3 is a schematic diagram of a Qos mechanism;

FIG. 4 is a schematic diagram of transmission of PDU sets according to an embodiment of the present disclosure;

FIG. 5 is a first flowchart of a data transmission method according to an embodiment of the present disclosure;

FIG. 6 is a second flowchart of a data transmission method according to an embodiment of the present disclosure;

FIG. 7A is a first schematic diagram of a format of a downlink SDAP control PDU according to an embodiment of the present disclosure;

FIG. 7B is a second schematic diagram of a format of a downlink SDAP control PDU according to an embodiment of the present disclosure;

FIG. 8A is a first schematic diagram of a format of a downlink SDAP data PDU according to an embodiment of the present disclosure;

FIG. 8B is a second schematic diagram of a format of a downlink SDAP data PDU according to an embodiment of the present disclosure;

FIG. 8C is a third schematic diagram of a format of a downlink SDAP data PDU according to an embodiment of the present disclosure;

FIG. 8D is a fourth schematic diagram of a format of a downlink SDAP data PDU according to an embodiment of the present disclosure;

FIG. 9 is a third flowchart of a data transmission method according to an embodiment of the present disclosure;

FIG. 10A is a first schematic diagram of a protocol stack of a first node according to an embodiment of the present disclosure;

FIG. 10B is a second schematic diagram of a protocol stack of a first node according to an embodiment of the present disclosure;

FIG. 11 is a fourth flowchart of a data transmission method according to an embodiment of the present disclosure;

FIG. 12 is a first schematic structural diagram of a data transmission device according to an embodiment of the present disclosure;

FIG. 13 is a second schematic structural diagram of a data transmission device according to an embodiment of the present disclosure;

FIG. 14 is a third schematic structural diagram of a data transmission device according to an embodiment of the present disclosure.

FIG. 15 is a fourth schematic structural diagram of a data transmission device according to an embodiment of the present disclosure;

FIG. 16 is a fifth schematic structural diagram of a data transmission device according to an embodiment of the present disclosure;

FIG. 17 is a schematic structural diagram of a communication device according to an embodiment of the present disclosure;

FIG. 18 is a schematic structural diagram of a chip according to an embodiment of the present disclosure; and

FIG. 19 is a schematic block diagram of a communication system according to an embodiment of the present disclosure.

### DETAILED DESCRIPTION

The technical schemes in the embodiments of the application will be described below in conjunction with the drawings in the embodiments of the application. It is apparent that the described embodiments are a part of the embodiments of the application, not all of the embodiments. Based on the embodiments in the application, all other embodiments obtained by those skilled in the art without creative effort belong to the protection scope of the application.

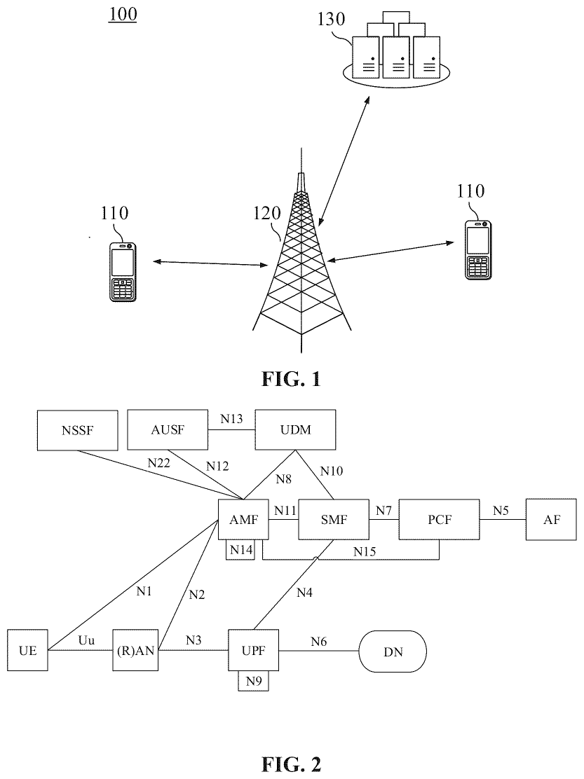

FIG. 1 is a schematic diagram of an application scenario to which an embodiment of the present disclosure is applied.

As shown in FIG. 1, the communication system 100 may include a terminal device 110 and a network device 120. The network device 120 may communicate with the terminal device 110 through an air interface. Multi-service transmission is supported between the terminal device 110 and the network device 120.

It should be understood that the embodiments of the present disclosure are only illustrative with the communication system 100 but are not limited thereto. That is to say, the technical schemes of the embodiments of the present disclosure can be applied to various communication systems, such as: a Long Term Evolution (LTE) system, a LTE Time Division Duplex (TDD), an Universal Mobile Telecommunications System (UMTS), an Internet of Things (IoT) system, a Narrow Band Internet of Things (NB-IoT) system, an Enhanced Machine-Type Communications (cMTC) system, a 5G communication system (also referred to as a New Radio (NR) communication system), or a future communication system (e.g. 6G communication system, or 7G communication system), etc.

In the communication system 100 shown in FIG. 1, the network device 120 may may an access network device that communicates with the terminal device 110. The access network device may provide communication coverage for a particular geographic area and may communicate with a terminal device 110 (e.g., User equipment (UE)) located within the coverage.

The network device 120 may be an Evolved Node B (also called as eNB or eNodeB) in the LTE system, or a Next Generation Radio Access Network (NG RAN) device, or a base station (gNB) in the NR system, or a wireless controller in a Cloud Radio Access Network (CRAN), or the network device 120 may be a relay station, an access point, a vehicle-mounted device, a wearable device, a hub, a switch, a bridge, a router, or a network device in a future evolved Public Land Mobile Network (PLMN), etc.

The terminal device 110 may be any terminal device including, but not limited to, a terminal device in wired or wireless connection with the network device 120 or other terminal devices.

For example, the terminal device 110 may be an access terminal, a UE, a subscriber unit, a subscriber station, a mobile station, a remote station, a remote terminal, a mobile device, a user terminal, a terminal, a wireless communication device, a user agent, or a user device. The access terminal may be a cellular telephone, a cordless telephone, a Session Initiation Protocol (SIP) telephone, an IoT device, a satellite handheld terminal, a Wireless Local Loop (WLL) station, a Personal Digital Assistant (PDA), a handheld device having a wireless communication function, a computing device or other processing device connected to a wireless modem, a vehicle-mounted device, a wearable device, a terminal device in a 5G network or a terminal device in a future evolution network, etc.

The terminal device 110 may be used for the Device to Device (D2D) communication.

The wireless communication system 100 may also include a core network device 130 that communicates with the base station. The core network device 130 may be a 5G Core (5GC) device, for example, an Access and Mobility Management Function (AMF), for another example, an Authentication Server Function (AUSF), for another example, a User Plane Function (UPF), and for another example, a Session Management Function (SMF). Optionally, the core network device 130 may also be an Evolved Packet Core (EPC) device of the LTE network, for example, a Session Management Function+Core Packet Gateway (SMF+PGW-C) device. It should be understood that SMF+PGW-C device can implement the functions implemented by the SMF and PGW-C. In a process of network evolution, the core network device may also be called by other names, or a new network entity may be formed by partitioning the functions of the core network, which is not limited in the embodiments of the present disclosure.

The communication between the functional units of the communication system 100 may be implemented by establishing a connection through a next generation (NG) interface.

For example, the terminal device sets up the air interface connection with the access network device through an NR interface, to transmit or receive user plane data and control plane signaling. The terminal device may set up a control plane signaling connection with an AMF through an NG interface 1 (abbreviated as N1). The access network device, such as the gNB, may set up a user plane data connection with a UPF through an NG interface 3 (abbreviated as N3). The access network device may set up a control plane signaling connection with the AMF through an NG interface 2 (abbreviated as N2). The UPF may set up a control plane signaling connection with an SMF through an NG interface 4 (abbreviated as N4). The UPF may exchange user plane data with a data network through an NG interface 6 (abbreviated as N6). The AMF may set up a control plane signaling connection with the SMF through an NG interface 11 (abbreviated as N11). The SMF may set up a control plane signaling connection with a PCF through an NG Interface 7 (abbreviated as N7).

FIG. 1 exemplarily illustrates one base station, one core network device and two terminal devices. Optionally, the wireless communication system 100 may include multiple base station devices and other numbers of the terminal devices may be included within the coverage of each base station, which is not limited in the embodiments of the present disclosure.

It should be noted that FIG. 1 only illustrates by way of example the system to which the present disclosure applies and of course the method shown in the embodiment of the present disclosure may also be applied to other systems. In addition, the terms “system” and “network” herein are often used interchangeably herein. In this disclosure, the term “and/or” is only to describe an association relationship between associated objects and represents that three kinds of relationships may exist. For example, A and/or B may represent three conditions: i.e., independent existence of A, existence of both A and B and independent existence of B. In addition, the character “/” in the present disclosure generally indicates that the associated objects before and after this character is in an “or” relationship. It should be understood that the reference to “indication” in the embodiments of the present disclosure may be a direct indication, may be an indirect indication, or may be indicative of an association. For example, A indicates B, which may mean that A directly indicates B, for example, B may be obtained through A; it may also mean that A indirectly indicates B, for example, A indicates C, and B may be obtained by C; and it may also indicate that there is an association between A and B. It should also be understood that the term “correspondence” may mean that there is a direct correspondence or an indirect correspondence between the two, may also mean that there is an association relationship between the two, and may also be a relationship between indication and being indicated, configuration and being configured, etc. It should also be understood that “predefined” or “predefined rules” may be achieved by pre-storing corresponding codes, tables or other means used for indicating relevant information in devices (e.g., including terminal devices and network devices), and the present disclosure is not limited to the specific implementation thereof. For example, predefined may refer to what is defined in the protocol. It should also be understood that, in the embodiments of the present disclosure, the “protocol” may be a standard protocol in the communication field. For example, the protocol may include an LTE protocol, an NR protocol, and related protocols applied in future communication systems, which are not limited in the present disclosure.

In order to facilitate understanding of the technical schemes of the embodiments of the present disclosure, the technical technologies related to the embodiments of the present disclosure are described below, and the following related technologies, as optional schemes, can be arbitrarily combined with the technical schemes of the embodiments of the present disclosure, all of which belong to the protection scope of the embodiments of the present disclosure.

### 5G Network Architecture

FIG. 2 is a diagram of the 5G network system architecture. As shown in FIG. 2, the network elements involved in the 5G network system include: UE, a Radio Access Network (RAN), a User Plane Function (UPF), a Data Network (DN), an Access and Mobility Management Function (AMF), a Session Management Function (SMF), a Policy Control Function (PCF), an Application Function (AF), an Authentication Server Function (AUSF), and an Unified Data Management (UDM).

AS shown in FIG. 2, the UE performs an Access Stratum (AS) connection, exchanges AS messages and performs wireless data transmission with the RAN through the Uu interface. The UE performs a Non-Access Stratum (NAS) connection and exchanges NAS messages with the AMF through the N1 interface. The AMF is a mobility management function in the core network, and the SMF is a session management function in the core network. The AMF is also responsible for forwarding messages related to the session management between the UE and the SMF, in addition to performing the mobility management on the UE. The PCF is a policy management function in the core network, which is responsible for formulating policies related to the mobility management, the session management, billing and the like for the UE. The UPF is a user plane function in the core network, which performs the data transmission with the DN through the N6 interface and performs the data transmission with the RAN through the N3 interface.

### Qos Mechanism

In a mobile communication network, in order to transmit user plane data, one or more Qos flows are required to be established. As an important measure of communication quality, Qos parameters are usually used for indicating the characteristics of the Qos flows, and different Qos flows correspond to different Qos parameters. The Qos parameters may include, but are not limited to: 5G Qos Identifier (5QI), Allocation Retension Priority (ARP), Guaranteed Flow Bit Rate (GFBR), Maximum Flow Bit Rate (MFBR), Uplink (UL)/Downlink (DL) Maximum Packet Loss Rate (UL/DL MPLR), Packet Delay Budget (PDB), Access Network PDB (AN-PDB), Packet Error Rate (PER), Priority Level, Averaging Window, Resource Type, Maximum Data Burst Volume, UE Aggregate Maximum Bit Rate (UE-AMBR), Session Aggregate Maximum Bit Rate (UE-AMBR), and the like.

A filter contains characteristic parameters describing data packets (such as some related parameters of IP packets and some related parameters of Ethernet packets), and is used for filtering out specific data packets to bind to specific Qos flows. Herein, the most commonly used filter is the IP five-tuple, i.e., the source IP address, the destination IP address, the source port number, the destination port number, and the protocol type.

With reference to FIG. 3, the UPF and the UE may form a filter according to a combination of characteristic parameters of the data packets (for example, the leftmost trapezoids and the rightmost parallelograms in FIG. 3 represent filters). The uplink or downlink data packets that are transmitted on the user plane and conform to the characteristic parameters of the data packets are filtered, and are bound to one certain Qos flow. The binding of the uplink Qos flow is performed by the UE, and the binding of the downlink Qos flow is performed by the UPF. In the Qos mechanism, one or more Qos flows may be mapped to a Data Resource Bearer (DRB) for transmission. For one Qos flow corresponding to a set of Qos parameters, the base station may establish a DRB according to the Qos parameters and bind the Qos flow to a specific DRB.

The establishment of the Qos flow is triggered by the SMF. When the Qos is required to be adjusted, both the UE side and the network side may trigger a PDU session modification procedure to change the Qos. Taking the UE as an example, the UE may modify the Qos parameters of the Qos flow or establish a new Qos flow by sending a PDU Session Modification Request message. That is to say, when the UE adjusts the Qos, a session modification procedure is required to be performed, and the adjustment must be agreed by the network. Since the PDU session modification procedure takes a long time, and there is no guarantee that the modification must be successful, the behavior of the application may be affected. That is to say, the application cannot accurately determine whether it may use the desired Qos and how long it may wait to use the desired Qos, which will have a greater impact on many real-time services, such as machine learning and neural network analysis. There are also many cases that cause the Qos changes. As an example, the following cases may cause the Qos changes: 1) a base station handover occurs; 2) network congestion occurs (such as a sudden increase in the number of users); and 3) The UE is moved in or out of a specific range (such as a service range of an edge server).

In order to facilitate understanding of the technical schemes of the embodiments of the present disclosure, the terms related to the embodiments of the present disclosure are described below, and the following meanings of the related terms, as optional schemes, can be arbitrarily combined with the technical schemes of the embodiments of the present disclosure, all of which belong to the protection scope of the embodiments of the present disclosure.

Cloud Gaming (CG): it refers to a set of use cases where the vast majority of game-related computing (single-player or multi-player) is offloaded from the UE to the edge server or remote server.

Extended Reality (XR): it refers to a large-range umbrella for multiple heterogeneous use cases and services. XR use cases may be roughly divided into: Augmented Reality (AR), Virtual Reality (VR), and Mixed Reality (MR).

Extended Reality and media services (XRM): it refers to a technology for combining the XR and the media services.

Video Slice: a spatially distinct region of a video frame that is encoded separately from other regions in the same frame.

PDU Set: it is composed of one or more PDUs carrying the payload of an information unit generated at the application layer (e.g., a frame or video slice for XRM services). These pieces of information have a same importance requirement at the application layer. All PDUs in a PDU Set are needed by the application layer to use the corresponding unit of information. In some cases, when some PDUs are missing, the application layer can still recover part of the information units.

I-frame: as an intra-coded picture, it is a complete picture and can be encoded and decoded independently, like a JPG image file.

P-frame: as a predicted picture, it is not a complete frame and only contains the image changes compared to the previous frame. If the reference frame is lost, the P-frame cannot be decoded and displayed.

B-frame: as a bidirectional predicted picture, it contains changes between the previous and following reference frames. The more the reference frames, the higher the compression ratio. However, the B-frame can only be decoded when the previous and following reference frames are available.

A Group of Pictures (GOP): including a collection of successive video frames. The first frame in a GOP is an I-frame, and the following frames can be P-frames or B-frames.

For media services, I-frames, P-frames and B-frames may be generated in the procedure of video compression encoding and decoding. The PDU set is a group of PDUs representing a frame or a video slice. The PDUs in the PDU set are associated with each other, and losing any one of the PDUs in the PDU set may cause that the PDU set cannot be decoded successfully, which results in losing of a part of the video image. The I-frames, P-frames and B-frames have different degrees of importance. For example, one I-frame is associated with multiple P-frames, if the I-frame is lost, then all P-frames cannot be decoded; and if a P-frame is lost, the P-frame may be recovered through the I-frame and other P-frames. Therefore, the I-frame is very important and cannot be lost.

However, in a current mobile communication system, a radio air interface can only identify individual data packets (i.e. PDUs) when the data to be transmitted is processed. As a result, these associations cannot be taken into account in the data transmission procedure. The data packets (i.e. PDUs) having the association relationship are carried on a same Qos flow or data bearer. In the air interface data transmission and processing, a same processing manner is applied to the data packets on the same Qos flow or data bearer, and different processing manners may be not adopted because of different data. However, as to a PDU set, PDUs in different PDU sets have different processing requirements. Adopting different processing manners for different PDUs (i.e. data packets), can better improve the performance and user experiences of the multimedia services.

In view of this, the following technical schemes are proposed according to the embodiments of the present disclosure. It should be noted that the technical schemes of the embodiments of the present disclosure may be applied to, but is not limited to, the 5G NR system architecture, for example, they may also be applied to a future enhanced NR system architecture, etc.

In order to facilitate understanding of the technical schemes of the embodiments of the present disclosure, the technical schemes of the present disclosure will be described in detail below with reference to specific embodiments. The above related technologies, as optional schemes, can be arbitrarily combined with the technical schemes of the embodiments of the present disclosure, all of which belong to the protection scope of the embodiments of the present disclosure. The embodiments of the present disclosure include at least part of following contents.

For a GOP containing a set of frames, these frames may come from different Qos flows or from a same Qos flow. Each frame in the GOP has its own type, such as I-frame, B-frame, P-frame, etc. As one implementation, the GOP may include one I-frame and at least one P-frame and/or at least one B-frame associated with the I-frame. In order to be able to identify each frame belonging to the GOP, a GOP Identifier (ID) (such as GOP id number, GOP SN, or GOP index, etc.) is defined, and the GOP is identified by the GOP ID. Each frame in the GOP is associated with the GOP ID, so that each frame belonging to the GOP is identified by the GOP ID. It is to be noted that a format of the GOP ID is not limited to the GOP id number, the GOP SN, or the GOP index, etc., and the GOP ID may have another format, such as, a predetermined time interval or a predetermined period. In this case, each frame within the predetermined time interval or the predetermined period belongs to one GOP.

For a frame, i.e., a PDU set, it is composed of multiple PDUs. In order to facilitate data transmission/retransmission and scheduling on the air interface, a PDU set identifier (such as PDU set id number, PDU set SN, or PDU set index, etc.) is defined for each PDU set, and the PDU set is identified by the PDU set identifier. The PDU set identifier is unique within a GOP.

For a PDU, in order to identify each PDU in the PDU set, a PDU identifier (such as PDU id number, PDU SN, or PDU index, etc.) is defined for each PDU, and the PDU is identified by the PDU identifier. The PDU identifier is unique within the PDU set.

In summary, each PDU may be associated with at least one of the following information: a GOP identifier, a PDU set identifier, a PDU identifier, or a frame type.

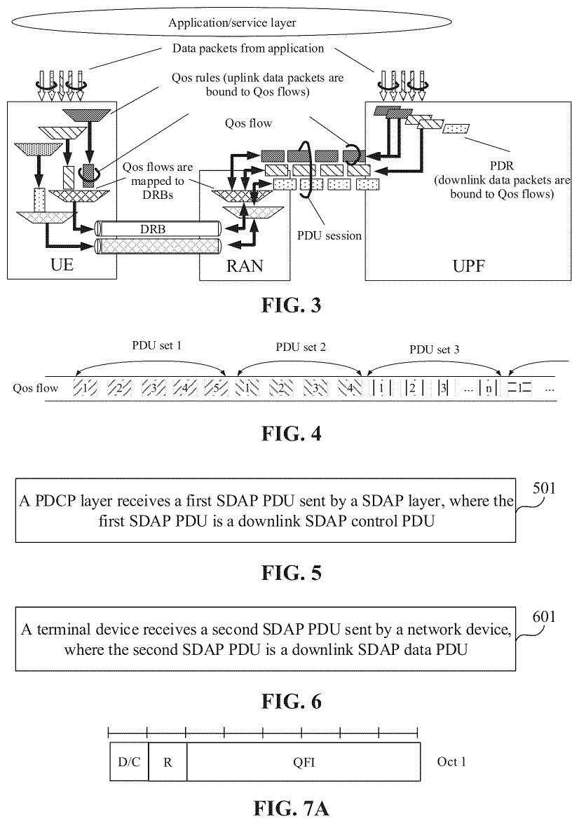

FIG. 4 is a schematic diagram of transmission of PDU sets according to an embodiment of the present disclosure. As shown in FIG. 4, the PDUs in a PDU set belong to one Qos flow, and these PDU sets are sequentially transmitted in a General Packet Radio Service (GPRS) Tunneling Protocol (GTP) tunnel. That is to say, there is no cross transmission between the PDU sets.

FIG. 5 is a first flowchart of a data transmission method according to an embodiment of the present disclosure. As shown in FIG. 5, the data transmission method includes operation 501.

In operation 501, a PDCP layer receives a first SDAP PDU sent by a SDAP layer, where the first SDAP PDU is a downlink SDAP control PDU.

In the embodiment of the present disclosure, the PDCP layer and the SDAP layer are protocol layers of a communication device. For the downlink transmission, the communication device is a network device, such as a base station.

In the embodiment of the present disclosure, the downlink SDAP control PDU is introduced for the downlink direction. Optionally, the downlink SDAP control PDU may be referred to as a Downlink SDAP End-Marker, and of course, the downlink SDAP control PDU may be referred to as another name, which is not limited in the present disclosure.

In some optional implementations, the downlink SDAP control PDU is generated by the SDAP layer (or SDAP entity) per Qos flow and is terminated at the local PDCP layer. In other words, the downlink SDAP control PDU is a downlink SDAP control PDU of a certain Qos flow. After the SDAP layer transmits the downlink SDAP control PDU to the local PDCP layer, the local PDCP layer identifies at least one piece of information based on the downlink SDAP control PDU, and then discards the downlink SDAP control PDU.

In some optional implementations, the transmission of the downlink SDAP control PDU is after one PDU set and/or before another PDU set, thereby splitting different PDU sets. For a downlink SDAP control PDU, its associated PDU set may be a latest PDU set before the downlink SDAP control PDU and/or a latest PDU set after the downlink SDAP control PDU.

It is to be noted that the PDU set represents a frame, and it is to be understood that the description of “PDU set” in the present disclosure may be replaced by the “frame” represented by it. Similarly, the description of “frame” in the present disclosure may be replaced by the corresponding “PDU set”.

In the embodiment of the present disclosure, the downlink SDAP control PDU has a specific format. Specifically, the downlink SDAP control PDU includes at least one of following information:
first information for indicating whether the first SDAP PDU is a data PDU or a control PDU;
second information for indicating a Qos flow ID associated with the first SDAP PDU;
third information for indicating a control PDU type to which the first SDAP PDU belongs;
fourth information for indicating a frame type corresponding to a PDU set or a frame associated with the first SDAP PDU;
fifth information for indicating a Qos attribute of the PDU set, the frame or a PDU associated with the first SDAP PDU;
sixth information for indicating an ID of the PDU set or the frame associated with the first SDAP PDU;
seventh information for indicating an ID of a Group of Pictures (GOP) to which the PDU set or the frame associated with the first SDAP PDU belongs; or
eighth information for indicating IDs of at least part of PDUs in the PDU set associated with the first SDAP PDU, such as an ID of each PDU in the PDU set.

Herein, the Qos flow ID associated with the first SDAP PDU may be an ID of a Qos flow to which the first SDAP PDU belongs, or an ID of a Qos flow to which a PDU set or a frame associated with the first SDAP PDU belongs.

In some optional implementations, the PDCP layer identifies at least one of following information based on the downlink SDAP control PDU:
SDAP PDUs or SDAP SDUs having an association relationship, where the association relationship means belonging to a same PDU set or a same frame;
the frame type of the PDU set or the frame;
the Qos attribute of the PDU set, the frame or the PDU;
the ID of the PDU set or the frame;
the ID of the GOP to which the PDU set or the frame belongs; or
the IDs of the at least part of PDUs in the PDU set, such as, an ID of each PDU in the PDU set.

In the above scheme, the frame type may be, for example, the I-frame, the P-frame, the B-frame, or another frame type.

In the above scheme, the Qos attribute includes, for example, whether or not packet loss is allowed, packet loss rate, latency, and the like.

In some optional implementations, the PDCP layer receives a second SDAP PDU sent by the SDAP layer, and the second SDAP PDU is a downlink SDAP data PDU. Herein, the downlink SDAP data PDU in a new format is introduced, and the downlink SDAP data PDU in the new format is different from the downlink SDAP data PDU in the old format. For convenience of description, the downlink SDAP data PDU in the new format is referred to as the downlink SDAP data PDU in the first format; and the downlink SDAP data PDU in the old format is referred to as the downlink SDAP data PDU in the second format. The downlink SDAP data PDU is used for carrying data information, and the data information may be information of one PDU or information of multiple of cascaded PDUs. In addition, the downlink SDAP data PDU may carry other additional information. Hereinafter, the downlink SDAP data PDU in the first format and the downlink SDAP data PDU in the second format will be described.

In the embodiment of the present disclosure, the downlink SDAP data PDU in the first format includes at least one of following information:
first information for indicating whether the second SDAP PDU is a data PDU or a control PDU;
second information for indicating a Qos flow ID associated with the second SDAP PDU;
third information for indicating a data PDU type to which the second SDAP PDU belongs;
fourth information for indicating a frame type corresponding to a PDU set or a frame associated with the second SDAP PDU;
fifth information for indicating a Qos attribute of the PDU set, the frame or a PDU associated with the second SDAP PDU;
sixth information for indicating an ID of the PDU set or the frame associated with the second SDAP PDU;
seventh information for indicating an ID of a GOP to which the PDU set or the frame associated with the second SDAP PDU belongs;
eighth information for indicating IDs of at least part of PDUs in the PDU set associated with the second SDAP PDU;
ninth information for indicating an RDI corresponding to the second SDAP PDU;
tenth information for indicating an RQI corresponding to the second SDAP PDU; or
data information.

Herein, the Qos flow ID associated with the second SDAP PDU may be an ID of a Qos flow to which the second SDAP PDU belongs, or an ID of a Qos flow to which the PDU set or the frame associated with the second SDAP PDU belongs.

In the above scheme, the frame type may be, for example, the I-frame, the P-frame, the B-frame, or another frame type.

In the above scheme, the Qos attribute includes, for example, whether or not packet loss is allowed, packet loss rate, latency, and the like.

In the above scheme, RDI is the abbreviation of Reflective QoS flow to DRB mapping Indication.

In the above scheme, RQI is the abbreviation of Reflective QoS Indication.

In the embodiment of the present disclosure, the downlink SDAP data PDU in the second format includes at least one of following information:
first information for indicating whether the second SDAP PDU is the data PDU or the control PDU;
second information for indicating a Qos flow ID associated with the second SDAP PDU; or
data information.

In some optional implementations, the downlink SDAP data PDU in the first format and the downlink SDAP data PDU in the second format need to coexist. For the network device, the network device needs to determine which format of the downlink SDAP data PDU is used. That is to say, the network device determines whether the format of the downlink SDAP data PDU is the first format or the second format. Herein, the network device may determine whether the format of the downlink SDAP data PDU is the first format or the second format by following first manner to the fourth manner.

In the first manner, if the network device receives first capability information reported by a terminal device, the network device determines that the format of the downlink SDAP data PDU is the first format; and if the network device does not receive the first capability information reported by the terminal device, the network device determines that the format of the downlink SDAP data PDU is the second format, where the first capability information is used for indicating that the terminal device supports the downlink SDAP data PDU in the first format.

Herein, in a case where the network device determines that the format of the downlink SDAP data PDU is the first format, an application range of the first format as the format of the downlink SDAP data PDU is a Qos flow corresponding to the target type of service or all Qos flows of the terminal device. Optionally, the target type of service is, for example, an XR service.

As an example, the first capability information may be referred to as capability indication information of the enhanced SDAP. Herein, if the terminal device reports the first capability information, both the network device and the terminal device use the first format as the format of the downlink SDAP data PDU by default (the application range is the Qos flow corresponding to the XR service or all the Qos flows of the terminal device); and otherwise, both the network device and the terminal device use the second format as the format of the downlink SDAP data PDU.

In the second manner, the network device receives second capability information reported by a terminal device; if the second capability information indicates that the terminal device supports a first capability, the network device determines that the format of the downlink SDAP data PDU is the first format; and if the second capability information indicates that the terminal device does not support the first capability, the network device determines that the format of the downlink SDAP data PDU is the second format, where the first capability is a capability that the terminal device supports the downlink SDAP data PDU in the first format, or the first capability is a capability that the terminal device supports a first protocol version. Herein, the first protocol version is, for example, Release 18 (Rel18) and a higher version.

Herein, in a case where the network device determines that the format of the downlink SDAP data PDU is the first format, an application range of the first format as the format of the downlink SDAP data PDU is a Qos flow corresponding to the target type of service or all Qos flows of the terminal device. Optionally, the target type of service is, for example, an XR service.

As an example, the first capability may be referred to as a capability of the enhanced SDAP, or alternatively, the first capability may be an enhanced protocol version capability. Herein, if the terminal device reports the second capability information, and the second capability information indicates the capability that the terminal device supports the downlink SDAP data PDU in the first format or the capability that the terminal device supports the Rel18, both the network device and the terminal device use the first format as the format of the downlink SDAP data PDU by default (the application range is the Qos flow corresponding to the XR service or all the Qos flows of the terminal device); and otherwise, both the network device and the terminal device use the second format as the format of the downlink SDAP data PDU.

In the third manner, if a terminal device is configured with a target type of service, the network device determines that the format of the downlink SDAP data PDU is the first format; and if the terminal device is not configured with the target type of service, the network device determines that the format of the downlink SDAP data PDU is the second format. Optionally, the target type of service is, for example, an XR service.

Herein, in a case where the network device determines that the format of the downlink SDAP data PDU is the first format, an application range of the first format as the format of the downlink SDAP data PDU is a Qos flow corresponding to the target type of service or all Qos flows of the terminal device.

As an example, if the terminal device is configured with the XR service, both the network device and the terminal device use the first format as the format of the downlink SDAP data PDU by default (the application range is the Qos flow corresponding to the XR service or all the Qos flows of the terminal device); and otherwise, both the network device and the terminal device use the second format as the format of the downlink SDAP data PDU.

In the fourth manner, the network device determines the format of the downlink SDAP data PDU by itself, and notifies the terminal device of the determined format of the downlink SDAP data PDU.

Specifically, the network device may configure indication information to the terminal device through RRC signaling. The indication information is used for instructing the terminal device to adopt which format as the format of the downlink SDAP data PDU. The indication information may be configured per Qos flow, configured per DRB, configured per PDU session, or configured per UE.

As an example, the indication information may be a Boolean value or an enumeration value. Three implementations of alternative indication information are given in Table 1 below. For example, the indication information is sDPA-Type, and has a value of old or new. The value of old represents the second format; and the value of new represents the first format. For example, the indication information is newSDPA-Type, and has a value of true or false. The value of true represents the first format; and the value of false represents the second format. For example, the indication information is newSDPA-Type, and has a value of a Boolean value. Different Boolean values represent different formats.

TABLE 1

sDPA-Type ENUMERATED {old, new} OPTIONAL,
newSDPA-Type ENUMERATED {true, false} OPTIONAL,
newSDPA-Type BOOLEAN OPTIONAL,

It is to be noted that the first manner to the fourth manner may be implemented individually. Alternatively, the fourth manner may be implemented in combination with the first manner, the second manner, or the third manner. When the manners are implemented in combination, the priority of the fourth manner is higher than that of the first manner to the third manner. That is to say, the terminal device preferentially determines the format of the downlink SDAP data PDU according to the indication information from the network device; and when the network device is not configured with the indication information, the terminal device determines the format of the downlink SDAP data PDU according to the first manner, the second manner, or the third manner.

According to the above technical schemes, on one hand, the downlink SDAP control PDU is introduced. The PDCP layer is capable of identifying the association between the PDUs and the association between PDU sets or frames through information carried in the downlink SDAP control PDU, so that these associations can be taken into account in the data transmission procedure, and the data transmission efficiency can be improved. On the other hand, the downlink SDAP data PDU in a new format is introduced. The PDCP layer is capable of identifying the association between the PDUs and the association between PDU sets or frames through information carried in the downlink SDAP data PDU in the new format, so that these associations can be taken into account in the data transmission procedure, and the data transmission efficiency can be improved. Moreover, in the case where the first node determines that the first data in the GOP is lost, the first node discards the second data in the GOP, thereby improving the transmission efficiency and reducing unnecessary data transmission. Furthermore, for different data packets, the PDCP layer adopts different discard timers according to at least one of a frame type, a Qos attribute, or a logical channel ID (LCID), thereby improving reliability of the data. In addition, the second node triggers the data recovery, and the first node performs the data recovery on partial data, thereby improving the reliability of the partial data.

FIG. 6 is a second flowchart of a data transmission method according to an embodiment of the present disclosure. As shown in FIG. 6, the data transmission method includes operation 601.

In operation 601, a terminal device receives a second SDAP PDU sent by a network device, where the second SDAP PDU is a downlink SDAP data PDU.

Herein, the downlink SDAP data PDU in a new format is introduced, and the downlink SDAP data PDU in the new format is different from the downlink SDAP data PDU in the old format. For convenience of description, the downlink SDAP data PDU in the new format is referred to as the downlink SDAP data PDU in the first format; and the downlink SDAP data PDU in the old format is referred to as the downlink SDAP data PDU in the second format. The downlink SDAP data PDU is used for carrying data information, and the data information may be information of one PDU or information of multiple of cascaded PDUs. In addition, the downlink SDAP data PDU may carry other additional information. Hereinafter, the downlink SDAP data PDU in the first format and the downlink SDAP data PDU in the second format will be described.

In the embodiment of the present disclosure, the downlink SDAP data PDU in the first format includes at least one of following information:
first information for indicating whether the second SDAP PDU is a data PDU or a control PDU;
second information for indicating a Qos flow ID associated with the second SDAP PDU;
third information for indicating a data PDU type to which the second SDAP PDU belongs;
fourth information for indicating a frame type corresponding to a PDU set or a frame associated with the second SDAP PDU;
fifth information for indicating a Qos attribute of the PDU set, the frame or a PDU associated with the second SDAP PDU;
sixth information for indicating an ID of the PDU set or the frame associated with the second SDAP PDU;
seventh information for indicating an ID of a GOP to which the PDU set or the frame associated with the second SDAP PDU belongs;
eighth information for indicating IDs of at least part of PDUs in the PDU set associated with the second SDAP PDU;
ninth information for indicating an RDI corresponding to the second SDAP PDU;
tenth information for indicating an RQI corresponding to the second SDAP PDU; or
data information.

Herein, the Qos flow ID associated with the second SDAP PDU may be an ID of a Qos flow to which the second SDAP PDU belongs, or an ID of a Qos flow to which the PDU set or the frame associated with the second SDAP PDU belongs.

In the above scheme, the frame type may be, for example, the I-frame, the P-frame, the B-frame, or another frame type.

In the above scheme, the Qos attribute includes, for example, whether or not packet loss is allowed, packet loss rate, latency, and the like.

In the above scheme, RDI is the abbreviation of Reflective QoS flow to DRB mapping Indication.

In the above scheme, RQI is the abbreviation of Reflective QoS Indication.

In the embodiment of the present disclosure, the downlink SDAP data PDU in the second format includes at least one of following information:
first information for indicating whether the second SDAP PDU is the data PDU or the control PDU;
second information for indicating a Qos flow ID associated with the second SDAP PDU; or
data information.

In some optional implementations, the downlink SDAP data PDU in the first format and the downlink SDAP data PDU in the second format need to coexist. For the terminal device, the terminal device needs to determine which format of the downlink SDAP data PDU is used. That is to say, the terminal device determines whether the format of the downlink SDAP data PDU is the first format or the second format. Herein, the terminal device may determine whether the format of the downlink SDAP data PDU is the first format or the second format by following first manner to the fourth manner.

In the first manner, if the terminal device reports first capability information to the network device, the terminal device and the network device determine that the format of the downlink SDAP data PDU is the first format; and if the terminal device does not report the first capability information to the network device, the terminal device and the network device determine that the format of the downlink SDAP data PDU is the second format, where the first capability information is used for indicating that the terminal device supports the downlink SDAP data PDU in the first format.

Herein, in a case where the terminal device and the network device determines that the format of the downlink SDAP data PDU is the first format, an application range of the first format as the format of the downlink SDAP data PDU is a Qos flow corresponding to the target type of service or all Qos flows of the terminal device. Optionally, the target type of service is, for example, an XR service.

As an example, the first capability information may be referred to as capability indication information of the enhanced SDAP. Herein, if the terminal device reports the first capability information, both the network device and the terminal device use the first format as the format of the downlink SDAP data PDU by default (the application range is the Qos flow corresponding to the XR service or all the Qos flows of the terminal device); and otherwise, both the network device and the terminal device use the second format as the format of the downlink SDAP data PDU.

In the second manner, the terminal device reports second capability information to the network device; if the second capability information indicates that the terminal device supports a first capability, the terminal device and the network device determine that the format of the downlink SDAP data PDU is the first format; and if the second capability information indicates that the terminal device does not support the first capability, the terminal device and the network device determines that the format of the downlink SDAP data PDU is the second format, where the first capability is a capability that the terminal device supports the downlink SDAP data PDU in the first format; or, the first capability is a capability that the terminal device supports a first protocol version.

Herein, in a case where the terminal device and the network device determines that the format of the downlink SDAP data PDU is the first format, an application range of the first format as the format of the downlink SDAP data PDU is a Qos flow corresponding to the target type of service or all Qos flows of the terminal device. Optionally, the target type of service is, for example, an XR service

As an example, the first capability may be referred to as a capability of the enhanced SDAP, or alternatively, the first capability may be an enhanced protocol version capability. Herein, if the terminal device reports the second capability information, and the second capability information indicates the capability that the terminal device supports the downlink SDAP data PDU in the first format or the capability that the terminal device supports the Rel18, both the network device and the terminal device use the first format as the format of the downlink SDAP data PDU by default (the application range is the Qos flow corresponding to the XR service or all the Qos flows of the terminal device); and otherwise, both the network device and the terminal device use the second format as the format of the downlink SDAP data PDU.

In the third manner, if the terminal device is configured with a target type of service, the terminal device and the network device determines that the format of the downlink SDAP data PDU is the first format; and if the terminal device is not configured with the target type of service, the terminal device and the network device determines that the format of the downlink SDAP data PDU is the second format.

Herein, in a case where the terminal device and the network device determines that the format of the downlink SDAP data PDU is the first format, an application range of the first format as the format of the downlink SDAP data PDU is a Qos flow corresponding to the target type of service or all Qos flows of the terminal device. Optionally, the target type of service is, for example, an XR service.

As an example, if the terminal device is configured with the XR service, both the network device and the terminal device use the first format as the format of the downlink SDAP data PDU by default (the application range is the Qos flow corresponding to the XR service or all the Qos flows of the terminal device); and otherwise, both the network device and the terminal device use the second format as the format of the downlink SDAP data PDU.

In the fourth manner, the terminal device receives first indication information sent by the network device, where the first indication information is used for indicating whether the first format or a second format is to be used by the terminal device as a format of the downlink SDAP data PDU; and the terminal device determines the format of the downlink SDAP data PDU based on the first indication information.

Herein, optionally, the first indication information is configured per Qos flow, configured per DRB, configured per PDU session, or configured per UE.

Herein, optionally, the first indication information is configured through RRC signaling.

As an example, the indication information may be a Boolean value or an enumeration value. Three implementations of alternative indication information are given in Table 1 above. For example, the indication information is sDPA-Type, and has a value of old or new. The value of old represents the second format, and the value of new represents the first format. For example, the indication information is newSDPA-Type, and has a value of true or false. The value of true represents the first format, and the value of false represents the second format. For example, the indication information is newSDPA-Type, and has a value of a Boolean value. Different Boolean values represent different formats.

The above scheme is illustrated below in conjunction with specific application examples.

### First Application Example

The format of the downlink SDAP control PDU may be, but is not limited to, following format 1 to format 2.

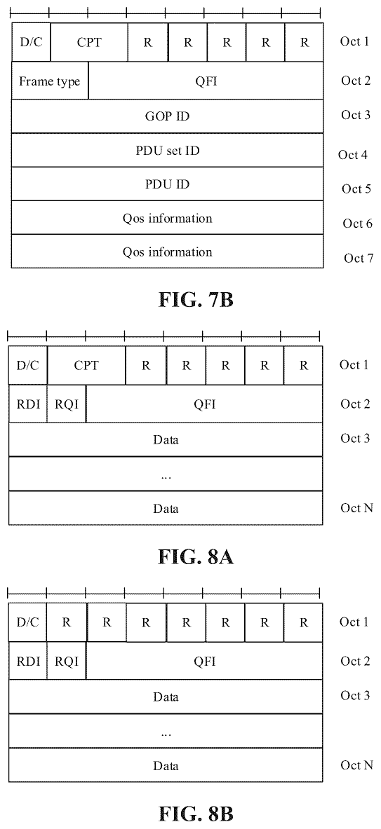

For the format 1, as shown in FIG. 7A, the downlink SDAP control PDU includes following information: the D/C (corresponding to the first information) and the Qos flow Identifier (QFI) (corresponding to the second information). The D/C is used for indicating whether the SDAP PDU is a data PDU or a control PDU. The QFI is used for indicating the Qos flow ID associated with the SDAP PDU. Optionally, the D/C occupies 1 bit. Herein, a value of the 1 bit is 0, which is used for indicating that the SDAP PDU is the control PDU.

For the format 2, as shown in FIG. 7B, the downlink SDAP control PDU includes following information: the D/C (corresponding to the first information), the QFI (corresponding to the second information), the CPT (corresponding to the third information), frame type (corresponding to the fourth information), the GOP ID (corresponding to the seventh information), the PDU set ID (corresponding to the sixth information), PDU IDs (corresponding to the eighth information), and the Qos information (corresponding to the fifth information). The D/C information is used for indicating whether the SDAP PDU is the data PDU or the control PDU. The QFI is used for indicating the Qos flow ID associated with the SDAP PDU. The CPT is used for indicating a control PDU type to which the SDAP PDU belongs. The frame type is used for indicating a frame type corresponding to a PDU set or a frame associated with the SDAP PDU. The GOP ID is used for indicating an ID of a GOP to which the PDU set or the frame associated with the SDAP PDU belongs. The PDU set ID is used for indicating an ID of the PDU set or the frame associated with the SDAP PDU. The PDU IDs are used for indicating IDs of at least part of PDUs in the PDU set associated with the SDAP PDU. The Qos information is used for indicating Qos attribute of the PDU set, the frame or a PDU associated with the SDAP PDU. Optionally, the D/C occupies 1 bit. Herein, a value of the 1 bit is 0, which is used for indicating that the SDAP PDU is the control PDU.

### Second Application Example

The downlink SDAP data PDU in the first format may be, but is not limited to, following format 1 to format 4.

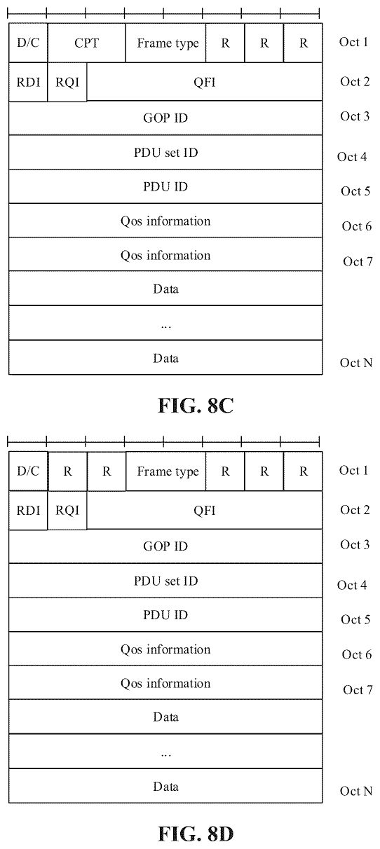

For the format 1, as shown in FIG. 8A, the downlink SDAP data PDU includes following information: the D/C (corresponding to the first information), the QFI (corresponding to the second information), the CPT (corresponding to the third information), the RDI (corresponding to the ninth information), the RQI (corresponding to the tenth information), and the data information. The D/C is used for indicating whether the SDAP PDU is a data PDU or a control PDU. The QFI is used for indicating the Qos flow ID associated with the SDAP PDU. The CPT is used for indicating a control PDU type to which the SDAP PDU belongs.

For the format 2, as shown in FIG. 8B, the downlink SDAP data PDU includes following information: the D/C (corresponding to the first information), the QFI (corresponding to the second information), the RDI (corresponding to the ninth information), the RQI (corresponding to the tenth information), and the data information. The D/C is used for indicating whether the SDAP PDU is a data PDU or a control PDU. The QFI is used for indicating the Qos flow ID associated with the SDAP PDU.

For the format 3, as shown in FIG. 8C, the downlink SDAP data PDU includes following information: the D/C (corresponding to the first information), the QFI (corresponding to the second information), the CPT (corresponding to the third information), the frame type (corresponding to the fourth information), the GOP ID (corresponding to the seventh information), the PDU set ID (corresponding to the sixth information), the PDU IDs (corresponding to the eighth information), the Qos information (corresponding to the fifth information), the RDI, the RQI, and data information. The D/C information is used for indicating whether the SDAP PDU is the data PDU or the control PDU. The QFI is used for indicating the Qos flow ID associated with the SDAP PDU. The CPT is used for indicating a control PDU type to which the SDAP PDU belongs. The frame type is used for indicating a frame type corresponding to a PDU set or a frame associated with the SDAP PDU. The GOP ID is used for indicating for indicating an ID of a GOP to which the PDU set or the frame associated with the SDAP PDU belongs. The PDU set ID is used for indicating an ID of the PDU set or the frame associated with the SDAP PDU. The PDU IDs are used for indicating IDs of at least part of PDUs in the PDU set associated with the SDAP PDU. The Qos information is used for indicating Qos attribute of the PDU set, the frame or a PDU associated with the SDAP PDU.

For the format 4, as shown in FIG. 8D, the downlink SDAP data PDU includes following information: the D/C (corresponding to the first information), the QFI (corresponding to the second information), the frame type (corresponding to the fourth information), the GOP ID (corresponding to the seventh information), the PDU set ID (corresponding to the sixth information), the PDU IDs (corresponding to the eighth information), the Qos information (corresponding to the fifth information), the RDI, the RQI, and the data information. The D/C information is used for indicating whether the SDAP PDU is the data PDU or the control PDU. The QFI is used for indicating the Qos flow ID associated with the SDAP PDU. The frame type is used for indicating a frame type corresponding to a PDU set or a frame associated with the SDAP PDU. The GOP ID is used for indicating for indicating an ID of a GOP to which the PDU set or the frame associated with the SDAP PDU belongs. The PDU set ID is used for indicating an ID of the PDU set or the frame associated with the SDAP PDU. The PDU IDs are used for indicating IDs of at least part of PDUs in the PDU set associated with the SDAP PDU. The Qos information is used for indicating Qos attribute of the PDU set, the frame or a PDU associated with the SDAP PDU.

According to the technical schemes of the embodiment of the present disclosure, on one hand, the downlink SDAP control PDU is introduced. The PDCP layer is capable of identifying the association between the PDUs and the association between PDU sets or frames through information carried in the downlink SDAP control PDU, so that these associations can be taken into account in the data transmission procedure, and the data transmission efficiency can be improved. On the other hand, the downlink SDAP data PDU in a new format is introduced. The PDCP layer is capable of identifying the association between the PDUs and the association between PDU sets or frames through information carried in the downlink SDAP control PDU having the new format, so that these associations can be taken into account in the data transmission procedure, and the data transmission efficiency can be improved.

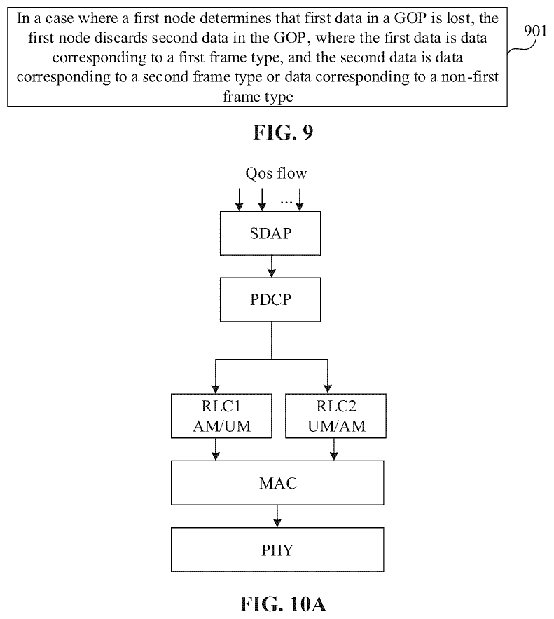

FIG. 9 is a third flowchart of a data transmission method according to an embodiment of the present disclosure. As shown in FIG. 9, the data transmission method includes operation 901.

In operation 901, in a case where a first node determines that first data in a GOP is lost, the first node discards second data in the GOP, where the first data is data corresponding to a first frame type, and the second data is data corresponding to a second frame type or data corresponding to a non-first frame type.

In the embodiment of the present disclosure, the first node is a sending end, and the sending end may send data to the receiving end. Optionally, the first node may be a network device (such as a base station), or the first node may be a terminal device.

In the embodiment of the present disclosure, in the case where the first node determines that the first data in the GOP is lost, the first node discards the second data in the GOP, where the first data is the data corresponding to the first frame type, and the second data is the data corresponding to the second frame type or the data corresponding to the non-first frame type. Herein, the first frame type is, for example, the I-frame, and the second frame type or non-first frame type is, for example, the B-frame and/or the P-frame.

It is to be noted that one piece of data may correspond to one PDU, one PDCP PDU, one PDCP SDU, one RLC PDU, or one RLC SDU in the PDU set. The number of pieces of the first data may be one or more, and the number of pieces of the second data may be one or more.

The following describes how the first node discards the data in conjunction with specific schemes.

It is to be noted that in the PDCP layer, each piece of data corresponds to one PDCP SN, the PDCP SN(s) corresponding to the first data includes one or more PDCP SNs. Similarly, the PDCP SN(s) corresponding to the second data includes one or more PDCP SNs.

### First Scheme

In some optional implementations, the first node has one PDCP entity and two RLC entities including a first RLC entity and a second RLC entity, where the PDCP entity is configured to transmit the first data and the second data, the first RLC entity is configured to transmit the first data and the second RLC entity is configured to transmit the second data.

In a case where the first RLC entity determines that the first data in the GOP is lost, the first RLC entity notifies the second RLC entity to discard the second data in the GOP.

Herein, a path order of the notification is:
the first RLC entity notifies the PDCP entity, and the PDCP entity notifies the second RLC entity; or
the first RLC entity notifies the second RLC entity.

In some optional implementations, the notification carries at least one of following information:
second indication information for indicating that the first data in the GOP is lost;
a GOP ID (ID) that is an ID of a GOP where the first data is lost;
a PDCP Sequence Number (SN) list for indicating PDCP SNs corresponding to the discarded one or more second data;
a starting PDCP SN for indicating a PDCP SN corresponding to discarded starting second data;
an ending PDCP SN for indicating a PDCP SN corresponding to discarded ending second data; or
a PDCP SN length for indicating a number of PDCP SNs corresponding to the discarded one or more second data.

Herein, the ending PDCP SN may not be carried in the notification, and the ending PDCP SN may be the PDCP SN corresponding to the latest data delivered by the PDCP entity to the second RLC entity by default.

### Second Scheme

In some optional implementations, the first node has two PDCP entities and two RLC entities, the two PDCP entities including a first PDCP entity and a second PDCP entity, and the two RLC entities including a first RLC entity and a second RLC entity, where the first PDCP entity and the first RLC entity are configured to transmit the first data, and the second PDCP entity and the second RLC entity are configured to transmit the second data.

In a case where the first RLC entity determines that the first data in the GOP is lost, the first RLC entity notifies at least one of an SDAP layer, the second PDCP entity, or the second RLC entity to discard the second data in the GOP.

Herein, the path order of the notification is:
the first RLC entity notifies the first PDCP entity, the first PDCP entity notifies the SDAP layer, the SDAP layer notifies the second PDCP entity, and the second PDCP entity notifies the second RLC entity; or
the first RLC entity notifies the first PDCP entity, the first PDCP entity notifies the second PDCP entity, and the second PDCP entity notifies the second RLC entity; or
the first RLC entity notifies the second RLC entity, the second RLC entity notifies the second PDCP entity, and the second PDCP entity notifies the SDAP layer; or
the first RLC entity notifies the second RLC entity, and the second RLC entity notifies the second PDCP entity; or
the first RLC entity notifies the second RLC entity.

In some optional implementations, the notification carries at least one of the following information:
second indication information for indicating that the first data in the GOP is lost;
a GOP ID that is an ID of a GOP where the first data is lost;
a PDCP SN list for indicating PDCP SNs corresponding to the discarded one or more second data;
a starting PDCP SN for indicating a PDCP SN corresponding to discarded starting second data;
an ending PDCP SN for indicating a PDCP SN corresponding to discarded ending second data; or
a PDCP SN length for indicating a number of PDCP SNs corresponding to the discarded one or more second data.

Herein, the ending PDCP SN may not be carried in the notification, and the ending PDCP SN may be the PDCP SN corresponding to the latest data delivered by the PDCP entity to the second RLC entity by default.

For the first scheme and the second scheme described above, the first RLC entity may determine whether the first data in the GOP is lost in a manner A and manner B.

In the manner A, the first RLC entity determines whether the first data in the GOP is lost based on an indication from an MAC layer.

Herein, the MAC layer is configured through Radio Resource Control (RRC) signaling with a function of: after the MAC layer completes transmission of data and obtains Acknowledgment (ACK)/Negative Acknowledgment (NACK) feedback information for the data, indicating based on the ACK/NACK feedback information, to the RLC layer, whether the data is transmitted correctly. Optionally, the function configured for the MAC layer is configured per LCID. For example, after the MAC layer transmits the data and obtains the ACK/NACK feedback information, the MAC layer indicates whether the data is correctly transmitted (i.e., whether the data is lost) to the RLC entity corresponding to the LCID to which the data belongs.

In the manner B, the first RLC entity determines whether the first data in the GOP is lost based on an ACK/NACK feedback from an RLC entity of a second node, where the second node is a receiving end for the first data.

The above scheme is illustrated below in conjunction with specific application examples.

### Third Application Example

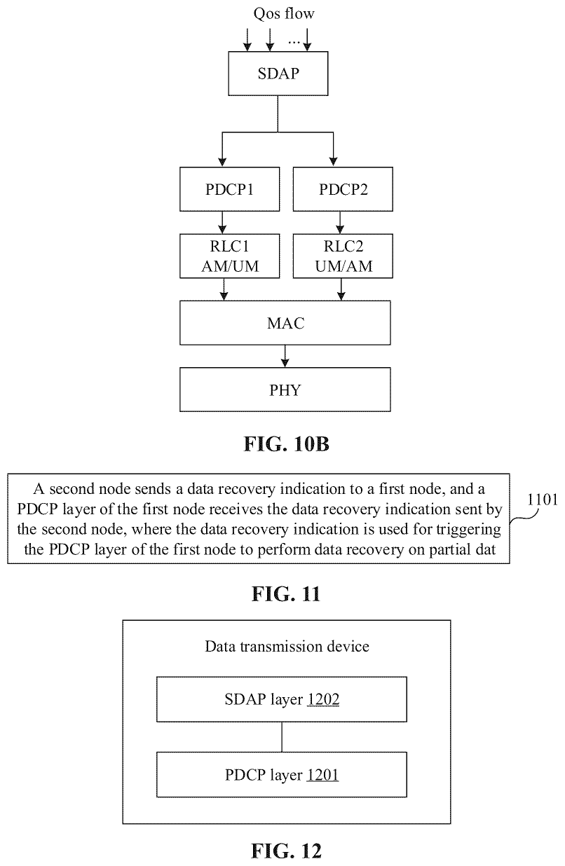

As shown in FIG. 10A, a protocol stack of the first node has one PDCP entity and two RLC entities including an RLC1 entity (corresponding to the first RLC entity) and an RLC2 entity (corresponding to the second RLC entity). The PDCP entity is used for transmitting I-frame data, the RLC1 entity is used for transmitting I-frame data, and the RLC2 entity is used for transmitting B-frame and/or P-frame data. Herein, a mode of the RLC1 entity may be an Acknowledgement (AM) mode or an Un-acknowledgement (UM) mode, and a mode of the RLC entity may be the UM mode or the AM mode.

In a scheme I-1, if the RLC1 entity determines that the I-frame data is lost, the RLC1 entity notifies the PDCP layer that the I-frame data is lost and notifies the PDCP layer of a GOP ID corresponding to the lost I-frame data, and the PDCP layer notifies the RLC2 entity to discard the B-frame and/or P-frame data corresponding to the GOP ID. Herein, the notification from the PDCP layer to the RLC2 entity may carry at least one of following information: a PDCP SN list, a starting PDCP SN, an ending PDCP SN, a PDCP SN length, and a GOP ID. Herein, the ending PDCP SN may be the PDCP SN corresponding to the latest data delivered by the PDCP entity to the RLC2 entity by default.

In a scheme I-2, if the RLC1 entity determines that I-frame data is lost, the RLC1 entity notifies the RLC2 entity to discard B-frame and/or P-frame data corresponding to the GOP ID. Herein, the notification from the RLC1 entity to the RLC2 entity may carry at least one of following information: the PDCP SN list, the starting PDCP SN, the ending PDCP SN, the PDCP SN length, and the GOP ID. Herein, the ending PDCP SN may be the PDCP SN corresponding to the latest data delivered by the PDCP entity to the RLC2 entity by default.

It is to be noted that in the protocol stack illustrated in FIG. 10A, the B-frame and the P-frame may share one RLC entity. Alternatively, it is also possible that the B-frame is used by one RLC entity and the P-frame is used by another RLC entity. That is to say, the protocol stack illustrated in FIG. 10A includes three RLC entities.

### Fourth Application Example

As shown in FIG. 10B, a protocol stack of the first node has two PDCP entities and two RLC entities. The two PDCP entities include a PDCP entity 1 (corresponding to a first PDCP entity) and a PDCP entity 2 (corresponding to a second PDCP entity); and the two RLC entities include an RLC1 entity (corresponding to a first RLC entity) and an RLC2 entity (corresponding to a second RLC entity). The PDCP1 entity and the RLC2 entity are used for transmitting I-frame data, and the PDCP2 entity and the RLC2 entity are used for transmitting B-frame and/or P-frame data. Herein, the mode of the RLC1 entity may be the AM mode or the UM mode, and the mode of the RLC entity may be the UM mode or the AM mode.

In a scheme II-1, if the RLC1 entity determines that the I-frame data is lost, the RLC1 entity notifies the PDCP1 entity that the I-frame data is lost and notifies the PDCP1 entity of the GOP ID corresponding to the lost I-frame data, and the PDCP1 entity notifies the SDAP layer that the I-frame data is lost and notifies the SDAP layer of the GOP ID corresponding to the lost I-frame data. The SDAP layer discards the B-frame data and/or P-frame data corresponding to the GOP ID, and the SDAP layer notifies the PDCP2 entity that the I-frame data is lost and notifies the PDCP2 entity of the GOP ID corresponding to the lost I-frame data. The PDCP2 entity discards the B-frame data and/or P-frame data corresponding to the GOP ID, and the PDCP2 entity notifies the RLC2 entity that the I-frame data is lost and notifies the RLC2 entity of the GOP ID corresponding to the lost I-frame data. The RLC2 entity discards the B-frame data and/or P-frame data corresponding to the GOP ID. Herein, the notification from the PDCP2 entity to the RLC2 entity may carry at least one of following information: the PDCP SN list, the starting PDCP SN, the ending PDCP SN, the PDCP SN length, and the GOP ID. Herein, the ending PDCP SN may be the PDCP SN corresponding to the latest data delivered by the PDCP entity to the RLC2 entity by default.

In a scheme II-2, if the RLC1 entity determines that the I-frame data is lost, the RLC1 entity notifies the PDCP1 entity that the I-frame data is lost and notifies the PDCP1 entity of the GOP ID corresponding to the lost I-frame data, and the PDCP1 entity notifies the PDCP2 entity that the I-frame data is lost and notifies the PDCP2 entity of the GOP ID corresponding to the lost I-frame data. The PDCP2 entity discards the B-frame data and/or P-frame data corresponding to the GOP ID, and the PDCP2 entity notifies the RLC2 entity that the I-frame data is lost and notifies the RLC2 entity of the GOP ID corresponding to the lost I-frame data. The RLC2 entity discards the B-frame data and/or P-frame data corresponding to the GOP ID. Herein, the notification from the PDCP2 entity to the RLC2 entity may carry at least one of following information: the PDCP SN list, the starting PDCP SN, the ending PDCP SN, the PDCP SN length, and the GOP ID. Herein, the ending PDCP SN may be the PDCP SN corresponding to the latest data delivered by the PDCP entity to the RLC2 entity by default.

In a scheme II-3, if the RLC1 entity determines that the I-frame data is lost, the RLC1 entity notifies the RLC2 entity that the I-frame data is lost and notifies the RLC2 entity of the GOP ID corresponding to the lost I-frame data. The RLC2 entity discards the B-frame data and/or P-frame data corresponding to the GOP ID. Herein, the notification from the RLC1 entity to the RLC2 entity may carry at least one of following information: the PDCP SN list, the starting PDCP SN, the ending PDCP SN, the PDCP SN length, and the GOP ID. Herein, the ending PDCP SN may be the PDCP SN corresponding to the latest data delivered by the PDCP entity to the RLC2 entity by default.

It is to be noted that in the protocol stack illustrated in FIG. 10B, the B-frame and the P-frame may share one RLC entity. Alternatively, it is also possible that the B-frame is used by one RLC entity and the P-frame is used by another RLC entity. That is to say, the protocol stack illustrated in FIG. 10B includes three RLC entities.

In some optional implementations, a PDCP layer of the first node is configured with at least one discard timer, and each of the at least one discard timer is associated with at least one of: a frame type, a Qos attribute, or an LCID. The PDCP layer determines a discard timer corresponding to received data based on at least one of a frame type, a Qos attribute or an LCID of the received data, and starts the discard timer corresponding to the received data after receiving the data.

The above scheme is illustrated below in conjunction with a specific application example.

### Fifth Application Example

The network side configures a dedicated bearer (i.e., a dedicated DRB) through RRC dedicated signaling, and the DRB includes one PDCP entity and at least one RLC entity. In the PDCP configuration of the PDCP entity, at least one discard timer, i.e., a PDCP layer discard timer, is configured, and each discard timer is associated with the frame type and/or the Qos attribute and/or the LCID. For example, two discard timers are configured, one discard timer (having longer duration) is associated with the I-frame, and the other discard timer (having shorter duration) is associated with the B-frame and/or P-frame. For example, two discard timers are configured, one discard timer is associated with a Qos attribute 1, and the other discard timer is associated with a Qos attribute 2. For example, two discard timers are configured, one discard timer is associated with an LCID1, and the other discard timer is associated with an LCID2. The configurations of the discard timer are given in Table 2 to Table 4 below. The PDCP layer determines a discard timer corresponding to received data based on at least one of a frame type, a Qos attribute or an LCID of the received data, and starts the discard timer corresponding to the received data after receiving the data.

TABLE 2

| | |
|---|---|
| PDCP-Config ::= | SEQUENCE { |
| drb | SEQUENCE { |
| DiscardtimerPerFrameList | SEQUENCE (SIZE(1..maxNrofDiscaardTimer)) OF |

DiscardtimerPerFrame
==omt some text===
}}

| | |
|---|---|
| DiscardtimerPerFrame ::= | SEQUENCE { |
| discardTimer | ENUMERATED {ms10, ms20, ms30, ms40, ms50, ms60, ms75, |

ms100, ms150, ms200,

ms250, ms300, ms500, ms750, ms1500, infinity} OPTIONAL,

-- Cond Setup

| | |
|---|---|
| frameType ENUMERATED {I,B,P} | OPTIONAL |

}

TABLE 3

| | |
|---|---|
| PDCP-Config ::= | SEQUENCE { |
| drb | SEQUENCE { |
| DiscardtimerPerQosList | SEQUENCE (SIZE(1..maxNrofDiscaardTimer)) OF |

DiscardtimerPerQos
==omt some text===
}}

| | |
|---|---|
| DiscardtimerPerQos ::= | SEQUENCE { |
| discardTimer | ENUMERATED {ms10, ms20, ms30, ms40, ms50, ms60, ms75, |

ms100, ms150, ms200,

ms250, ms300, ms500, ms750, ms1500, infinity} OPTIONAL,

-- Cond Setup

| | |
|---|---|
| Qosattribute ENUMERATED | OPTIONAL |

}

TABLE 4

| | |
|---|---|
| PDCP-Config ::= | SEQUENCE { |
| drb | SEQUENCE { |
| DiscardtimerPerLCIDList | SEQUENCE (SIZE(1..maxNrofDiscaardTimer)) OF |

DiscardtimerPerLCID
==omt some text===
}}

| | |
|---|---|
| DiscardtimerPerLCID ::= | SEQUENCE { |
| discardTimer | ENUMERATED {ms10, ms20, ms30, ms40, ms50, ms60, ms75, |

ms100, ms150, ms200,

ms250, ms300, ms500, ms750, ms1500, infinity} OPTIONAL,

-- Cond Setup

| | |
|---|---|
| LCID ENUMERATED | OPTIONAL |

}

According to the technical scheme of the embodiment of the present disclosure, in the case where the first node determines that the first data in the GOP is lost, the first node discards the second data in the GOP, thereby improving the transmission efficiency and reducing unnecessary data transmission. For different data packets, according to at least one of the frame type, the Qos attribute or the LCID, the PDCP layer adopts different discard timers, thereby improving the reliability of the data.

FIG. 11 is a fourth flowchart of a data transmission method according to an embodiment of the present disclosure, and as shown in FIG. 11, the data transmission method includes operation 1101.

In operation 1101, a second node sends a data recovery indication to a first node, and a PDCP layer of the first node receives the data recovery indication sent by the second node, where the data recovery indication is used for triggering the PDCP layer of the first node to perform data recovery on partial data.

In the embodiment of the present disclosure, the first node is the sending end, the second node is the receiving end, and the sending end may send data to the receiving end. Optionally, the first node may be a network device (such as a base station), and the second node may be a terminal device. Alternatively, the first node may be a terminal device, and the second node may be a network device, such as a base station. Alternatively, the first node may be a first terminal device and the second node may be a second terminal device.

In the embodiment of the present disclosure, the receiving end may trigger the recovery of the partial data. Specifically, the receiving end sends a data recovery indication to the sending end, and the data recovery indication is used for triggering the PDCP layer of the sending end to perform the data recovery on the partial data. Herein, optionally, the partial data may refer to data of a specific frame type (such as the I-frame data), data having a specific Qos attribute, or data with a specific LCID. For example, if the PDCP layer of the receiving end determines that the I-frame data is lost (i.e., the PDCP layer of the receiving end determines that the trigger condition is satisfied), the receiving end may trigger the PDCP entity of the sending end to perform the data recovery on the frame data.

In some optional implementations, the data recovery indication is carried in the MAC CE or the DCI.

In some optional implementations, the data recovery indication includes at least one of following information associated with the partial data: a DRB ID, a GOP ID list, a PDU set ID list, or a frame type.

In some optional implementations, the trigger condition for sending the data recovery indication includes at least one of:
an Intra-Centralized Unit Handover (Intra-CU HO) occurs;
RLC release and add is performed based on an RRC configuration;
RLC reestablishment is performed by an RLC entity;
bearer type change is performed based on the RRC configuration; or
a PDCP layer of the second node determines that the trigger condition is satisfied (for example, the PDCP layer of the second node determines that the I-frame data is lost).

Herein, the Intra-CU HO may be understood as that a Centralized Unit (CU) of the serving cell remains unchanged before and after the handover, while a Distributed Unit (DU) changes before and after the handover.

Herein, the determining by the PDCP layer of the second node that the trigger condition is satisfied may be implemented through following manner a to manner d.

In the manner a, after sending the data recovery indication, the PDCP layer of the second node starts a first timer and setting a most recently received PDCP SN as a first recovery PDCP SN; and if a PDCP SN that is not received by the PDCP layer of the second node exists within a first PDCP SN range when the first timer expires, the PDCP layer of the second node determines that the trigger condition is satisfied, where the first PDCP SN range includes the first recovery PDCP SN and a PDCP SN prior to the first recovery PDCP SN; or the first PDCP SN range includes a PDCP SN between the first recovery PDCP SN and a second recovery PDCP SN. The second recovery PDCP SN is a corresponding recovery PDCP SN when the first timer was last started.

In the manner b, if a PDCP SN that is not received by the PDCP layer of the second node exists, the PDCP layer of the second node starts a second timer; and if the PDCP SN that is not received by the PDCP layer of the second node still exists when the second timer expires, the PDCP layer of the second node determines that the trigger condition is satisfied.

In the manner c, if a PDCP SN that is not received by the PDCP layer of the second node exists, the PDCP layer of the second node determines that the trigger condition is satisfied.

In the manner d, if a PDCP SN that is not received by the PDCP layer of the second node exists and data corresponding to the PDCP SN that is not received belongs to data corresponding to a first frame type, the PDCP layer of the second node determines that the trigger condition is satisfied. Herein, optionally, the first frame type may be the I-frame.

It is to be noted that the PDCP SN is the SN corresponding to the PDCP layer, and each data has one PDCP SN. The PDCP layer receiving one PDCP SN may be understood as that the PDCP layer receives one piece of data having the PDCP SN.

In some optional implementations, after the PDCP layer of the first node receives the data recovery indication sent by the second node, the PDCP layer of the first node resends the first data in a first window, where the first data is the data corresponding to the first frame type. Herein, optionally, the first frame type may be the I-frame.

Herein, optionally, an ending SN of the first window is a PDCP SN of a latest PDCP PDU delivered by the PDCP layer of the first node to an RLC layer, and a length of the first window is configured by RRC signaling.

Herein, optionally, the length of the first window is configured per UE, configured per PDCP, or configured per DRB.

Herein, optionally, the length of the first window is represented by a number of PDCP SNs, by time, or by a number of time-domain units. Herein, the time may be, for example, N seconds, N milliseconds, or the like. The time-domain unit may be, for example, a radio frame, a slot, a symbol, or the like. Furthermore, in a case where the time-domain unit is a slot, a length of the slot is a length of a slot corresponding to a reference Subcarrier Spacing (SCS), the reference SCS being an SCS configured by the RRC signaling or an SCS of an activated Bandwidth Part (BWP) where the data recovery indication is located.

According to the technical scheme of the embodiment of the present disclosure, the second node triggers the data recovery, and the first node performs the data recovery on the partial data, thereby improving the reliability of the partial data.

Preferred embodiments of the present disclosure have been described in detail with reference to the accompanying drawings, but the present disclosure is not limited to the specific details of the above embodiments. Within the scope of the technical conception of the present disclosure, various simple modifications may be made to the technical scheme of the present disclosure, and these simple modifications all fall within the scope of protection of the present disclosure. For example, each of the specific technical features described in the above specific embodiments may be combined in any suitable manner without contradiction, and various possible combinations are not further described in this disclosure in order to avoid unnecessary repetition. For another example, any combination may be made between the various embodiments of the present disclosure so long as it does not depart from the idea of the present disclosure and is also to be regarded as the present disclosure of the present disclosure. For another example, on the premise of no conflict, each embodiment described in the present disclosure and/or the technical features in each embodiment may be arbitrarily combined with the prior art, and the technical scheme obtained after the combination should also fall within the scope of protection of the present disclosure.

It is to be understood that, in various embodiments of the present disclosure, the sequence numbers of the above processes do not imply the sequence of execution, and the sequence of execution of each process should be determined according to its functions and internal logic, and should not constitute any limitation on the implementation process of the embodiments of the present disclosure. Furthermore, in embodiments of the present disclosure, the terms “downlink”, “uplink” and “sidelink” are used to represent the transmission direction of the signal or data. The term “downlink” is used to represent that a transmission direction of the signal or data is a first direction transmitted from a base station to the user equipment of the cell, the term “uplink” is used to represent that a transmission direction of the signal or data is a second direction transmitted from the user equipment of the cell to the base station, and the term “sidelink” is used to represent that a transmission direction of the signal or data is a third direction transmitted from the user equipment 1 to the user equipment 2. For example, a term “downlink signal” means that the transmission direction of the signal is the first direction. In addition, in embodiments of the present disclosure, the term “and/or” is only an association relationship describing associated objects and represents that three relationships may exist. For example, A and/or B may represent three conditions: i.e., independent existence of A, existence of both A and B, and independent existence of B. In addition, the character “/” in the present disclosure generally indicates that the relationship between the associated objects is “or”.

FIG. 12 is first schematic structural diagram of a data transmission device according to an embodiment of the present disclosure. As shown in FIG. 12, the device includes a PDCP layer 1201 and an SDAP layer 1202.

The SDAP layer 1202 is configured to send a first SDAP PDU to the PDCP layer 1201.

The PDCP layer 1201 is configured to receive the first SDAP PDU sent by the SDAP layer 1202. The first SDAP PDU is a downlink SDAP control PDU including at least one of following information:
first information for indicating whether the first SDAP PDU is a data PDU or a control PDU;
second information for indicating a Quality of Service (Qos) flow Identifier (ID) associated with the first SDAP PDU;
third information for indicating a control PDU type to which the first SDAP PDU belongs;
fourth information for indicating a frame type corresponding to a PDU set or a frame associated with the first SDAP PDU;
fifth information for indicating a Qos attribute of the PDU set, the frame or a PDU associated with the first SDAP PDU;
sixth information for indicating an ID of the PDU set or the frame associated with the first SDAP PDU;
seventh information for indicating an ID of a Group of Pictures (GOP) to which the PDU set or the frame associated with the first SDAP PDU belongs; or
eighth information for indicating IDs of at least part of PDUs in the PDU set associated with the first SDAP PDU.

In some optional implementations, the PDCP layer 1201 is further configured to identify at least one of following information based on the downlink SDAP control PDU:
SDAP PDUs or SDAP SDUs having an association relationship, where the association relationship means belonging to a same PDU set or a same frame;
the frame type of the PDU set or the frame;
the Qos attribute of the PDU set, the frame or the PDU;
the ID of the PDU set or the frame;
the ID of the GOP to which the PDU set or the frame belongs; or
the IDs of the at least part of PDUs in the PDU set.

In some optional implementations, the PDCP layer 1201 is further configured to discard the downlink SDAP control PDU after identifying at least one of the information based on the downlink SDAP control PDU.

In some optional implementations, the PDCP layer 1201 is further configured to receive a second SDAP PDU sent by the SDAP layer 1202. The second SDAP PDU is a downlink SDAP data PDU, and the downlink SDAP data PDU in the first format includes at least one of following information:
first information for indicating whether the second SDAP PDU is a data PDU or a control PDU;
second information for indicating a Qos flow ID associated with the second SDAP PDU;
third information for indicating a data PDU type to which the second SDAP PDU belongs;
fourth information for indicating a frame type corresponding to a PDU set or a frame associated with the second SDAP PDU;
fifth information for indicating a Qos attribute of the PDU set, the frame or a PDU associated with the second SDAP PDU;
sixth information for indicating an ID of the PDU set or the frame associated with the second SDAP PDU;
seventh information for indicating an ID of a GOP to which the PDU set or the frame associated with the second SDAP PDU belongs;
eighth information for indicating IDs of at least part of PDUs in the PDU set associated with the second SDAP PDU;
ninth information for indicating an RDI corresponding to the second SDAP PDU;
tenth information for indicating an RQI corresponding to the second SDAP PDU; or
data information.

In some optional implementations, the PDCP layer 1201 and the SDAP layer 1202 are protocol layers of a network device. The network device is configured to determine whether a format of the downlink SDAP data PDU is a first format or a second format.

In some optional implementations, the network device is configured to: determine [00305] that the format of the downlink SDAP data PDU is the first format if the network device receives first capability information reported by a terminal device; and determine that the format of the downlink SDAP data PDU is the second format if the network device does not receive the first capability information reported by the terminal device. The first capability information is used for indicating that the terminal device supports the downlink SDAP data PDU in the first format.

In some optional implementations, the network device is configured to: receive second capability information reported by the terminal device; determine that that the format of the downlink SDAP data PDU is the first format if the second capability information indicates that the terminal device supports a first capability; and determine that the format of the downlink SDAP data PDU is the second format if the second capability information indicates that the terminal device does not support the first capability. The first capability is a capability that the terminal device supports the downlink SDAP data PDU in the first format, or the first capability is a capability that the terminal device supports a first protocol version.

In some optional implementations, the network device is configured to: determine that the format of the downlink SDAP data PDU is the first format if a terminal device is configured with a target type of service; and determine that the format of the downlink SDAP data PDU is the second format if the terminal device is not configured with the target type of service.

In some optional implementations, in a case where the network device determines that the format of the downlink SDAP data PDU is the first format, an application range of the first format as the format of the downlink SDAP data PDU is a Qos flow corresponding to the target type of service or all Qos flows of the terminal device.

In some optional implementations, the downlink SDAP data PDU in the second format includes at least one of following information:
first information for indicating whether the second SDAP PDU is the data PDU or the control PDU;
second information for indicating a Qos flow ID associated with the second SDAP PDU; or
data information.

Those skilled in the art will appreciate that the above-described description of the data transmission device in the embodiment of the present disclosure may be understood with reference to the description of the data transmission method in the embodiment of the present disclosure.

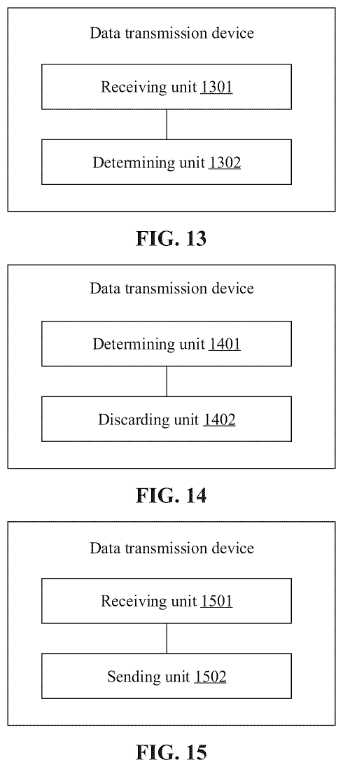

FIG. 13 is a second schematic structural diagram of a data transmission device according to an embodiment of the present disclosure. The data transmission device shown in FIG. 13 is applied to a terminal device. As shown in FIG. 13, the data transmission device includes a receiving unit 1301.

The receiving unit 1301 is configured to receive a second SDAP PDU sent by a network device, the second SDAP PDU being a downlink SDAP data PDU, where the downlink SDAP data PDU in the first format includes at least one of following information:
first information for indicating whether the second SDAP PDU is a data PDU or a control PDU;
second information for indicating a Qos flow ID associated with the second SDAP PDU;
third information for indicating a data PDU type to which the second SDAP PDU belongs;
fourth information for indicating a frame type corresponding to a PDU set or a frame associated with the second SDAP PDU;
fifth information for indicating a Qos attribute of the PDU set, the frame or a PDU associated with the second SDAP PDU;
sixth information for indicating an ID of the PDU set or the frame associated with the second SDAP PDU;
seventh information for indicating an ID of a GOP to which the PDU set or the frame associated with the second SDAP PDU belongs;
eighth information for indicating IDs of at least part of PDUs in the PDU set associated with the second SDAP PDU;
ninth information for indicating an RDI corresponding to the second SDAP PDU;
tenth information for indicating an RQI corresponding to the second SDAP PDU; or
data information.

In some optional implementations, the receiving unit 1301 is further configured to receive first indication information sent by the network device, where the first indication information is used for indicating whether the first format or a second format is to be used by the terminal device as a format of the downlink SDAP data PDU.

The device further includes a determining unit 1302 configured to determine the format of the downlink SDAP data PDU based on the first indication information.

In some optional implementations, the first indication information is configured per Qos flow, configured per DRB, configured per PDU session, or configured per UE.

In some optional implementations, the first indication information is configured through RRC signaling.

In some optional implementations, the device further includes a determining unit 1302 configured to: determine that the format of the downlink SDAP data PDU is the first format if the terminal device reports first capability information to the network device; and determine that the format of the downlink SDAP data PDU is the second format if the terminal device does not report the first capability information to the network device. The first capability information is used for indicating that the terminal device supports the downlink SDAP data PDU in the first format.

In some optional embodiments, the device further includes: a reporting unit configured to report second capability information to the network device.

The determining unit 1302 is configured to: determine that the format of the downlink SDAP data PDU is the first format if the second capability information indicates that the terminal device supports a first capability; and determine that the format of the downlink SDAP data PDU is the second format if the second capability information indicates that the terminal device does not support the first capability. The first capability is a capability that the terminal device supports the downlink SDAP data PDU in the first format; or, the first capability is a capability that the terminal device supports a first protocol version.

In some optional implementations, the device further includes the determining unit 1302 configured to: determine that the format of the downlink SDAP data PDU is the first format if the terminal device is configured with a target type of service; and determine that the format of the downlink SDAP data PDU is the second format if the terminal device is not configured with the target type of service.

In some optional implementations, in a case where the determining unit 1302 determines that the format of the downlink SDAP data PDU is the first format, an application range of the first format as the format of the downlink SDAP data PDU is a Qos flow corresponding to the target type of service or all Qos flows of the terminal device.

In some optional implementations, the downlink SDAP data PDU in the second format includes at least one of following information:
first information for indicating whether the second SDAP PDU is the data PDU or the control PDU;
second information for indicating a Qos flow ID associated with the second SDAP PDU; or
data information.

Those skilled in the art will appreciate that the above-described description of the data transmission device in the embodiment of the present disclosure may be understood with reference to the description of the data transmission method in the embodiment of the present disclosure.

FIG. 14 is a third schematic structural diagram of a data transmission device according to an embodiment of the present disclosure. The data transmission device shown in FIG. 14 is applied to a first node. As shown in FIG. 14, the data transmission device includes a determining unit 1401 and a discarding unit 1402.

The determining unit 1401 is configured to determine whether first data in a GOP is lost.

The discarding unit 1402 is configured to discard second data in the GOP in a case where the determining unit 1401 determines that first data in the GOP is lost. The first data is data corresponding to a first frame type, and the second data is data corresponding to a second frame type or data corresponding to a non-first frame type.

In some optional implementations, the first node has one PDCP entity and two RLC entities including a first RLC entity and a second RLC entity, where the PDCP entity is configured to transmit the first data and the second data, the first RLC entity is configured to transmit the first data and the second RLC entity is configured to transmit the second data.

In some optional implementations, in a case where the determining unit 1401 determines that the first data in the GOP is lost by the first RLC entity, the discarding unit 1402 notifies the second RLC entity to discard the second data in the GOP.

In some optional implementations, a path order of the notification is:
the first RLC entity notifies the PDCP entity, and the PDCP entity notifies the second RLC entity; or
the first RLC entity notifies the second RLC entity.

In some optional implementations, the first node has two PDCP entities and two RLC entities, the two PDCP entities including a first PDCP entity and a second PDCP entity, and the two RLC entities including a first RLC entity and a second RLC entity, where the first PDCP entity and the first RLC entity are configured to transmit the first data, and the second PDCP entity and the second RLC entity are configured to transmit the second data.

In some optional implementations, in a case where the determining unit 1401 determines that the first data in the GOP is lost through the first RLC entity, the discarding unit 1402 notifies at least one of the SDAP layer, the second PDCP entity, or the second RLC entity to discard the second data in the GOP.

In some optional implementations, the path order of the notification is:
the first RLC entity notifies the first PDCP entity, the first PDCP entity notifies the SDAP layer, the SDAP layer notifies the second PDCP entity, and the second PDCP entity notifies the second RLC entity; or
the first RLC entity notifies the first PDCP entity, the first PDCP entity notifies the second PDCP entity, and the second PDCP entity notifies the second RLC entity; or
the first RLC entity notifies the second RLC entity, the second RLC entity notifies the second PDCP entity, and the second PDCP entity notifies the SDAP layer; or
the first RLC entity notifies the second RLC entity, and the second RLC entity notifies the second PDCP entity; or
the first RLC entity notifies the second RLC entity.

In some optional implementations, the notification carries at least one of following information:
second indication information for indicating that the first data in the GOP is lost;
a GOP ID that is an ID of a GOP where the first data is lost;
a PDCP SN list for indicating PDCP SNs corresponding to the discarded one or more second data;
a starting PDCP SN for indicating a PDCP SN corresponding to discarded starting second data;
an ending PDCP SN for indicating a PDCP SN corresponding to discarded ending second data; or
a PDCP SN length for indicating a number of PDCP SNs corresponding to the discarded one or more second data.

In some optional implementations, the determining unit 1401 is further configured to determine whether the first data in the GOP is lost based on the indication from the MAC layer.

In some optional implementations, the MAC layer is configured through RRC signaling with a function of: after the MAC layer completes transmission of data and obtains ACK/NACK feedback information for the data, indicating based on the ACK/NACK feedback information, to the RLC layer, whether the data is transmitted correctly.

In some optional implementations, the function configured for the MAC layer is configured per LCID.

In some optional implementations, the determining unit 1401 is further configured to determine whether the first data in the GOP is lost based on an ACK/NACK feedback from an RLC entity of a second node, where the second node is a receiving end for the first data.

In some optional implementations, a PDCP layer of the first node is configured with at least one discard timer, and each of the at least one discard timer is associated with at least one of: a frame type, a Qos attribute, or an LCID.

In some optional implementations, the determining unit 1401 is further configured to: determine, by the PDCP layer, a discard timer corresponding to received data based on at least one of a frame type, a Qos attribute, and an LCID of the received data, and start the discard timer corresponding to the data after receiving the data.

Those skilled in the art will appreciate that the above-described description of the data transmission device in the embodiment of the present disclosure may be understood with reference to the description of the data transmission method in the embodiment of the present disclosure.

FIG. 15 is a fourth schematic structural diagram of a data transmission device according to an embodiment of the present disclosure. The data transmission device shown in FIG. 15 is applied to a first node. As shown in FIG. 15, the data transmission device includes a receiving unit 1501.

The receiving unit 1501 is configured to receive a data recovery indication sent by a second node, where the data recovery indication is used for triggering a PDCP layer of the first node to perform data recovery on partial data.

In some optional implementations, the data recovery indication includes at least one of following information associated with the partial data: a DRB ID, a GOP ID list, a PDU set ID list, or a frame type.

In some optional implementations, the trigger condition for sending the data recovery indication includes at least one of:
an Intra-Centralized Unit Handover (Intra-CU HO) occurs;
RLC release and add is performed based on an RRC configuration;
RLC reestablishment is performed by an RLC entity;
bearer type change is performed based on the RRC configuration; or
a PDCP layer of the second node determines that the trigger condition is satisfied.

In some optional implementations, the device further includes a sending unit 1502 configured to: resends the first data in a first window through the PDCP layer, where the first data is the data corresponding to the first frame type.

In some optional implementations, an ending SN of the first window is a PDCP SN of a latest PDCP PDU delivered by the PDCP layer of the first node to an RLC layer, and a length of the first window is configured by RRC signaling.

In some optional implementations, the length of the first window is configured per UE, configured per PDCP, or configured per DRB.

In some optional implementations, the length of the first window is represented by a number of PDCP SNs, by time, or by a number of time-domain units.

In some optional implementations, in a case where the time-domain unit is a slot, a length of the slot is a length of a slot corresponding to a reference SCS, the reference SCS being an SCS configured by the RRC signaling or an SCS of an activated BWP where the data recovery indication is located.

In some optional implementations, the data recovery indication is carried in the MAC CE or the DCI.

Those skilled in the art will appreciate that the above-described description of the data transmission device in the embodiment of the present disclosure may be understood with reference to the description of the data transmission method in the embodiment of the present disclosure.

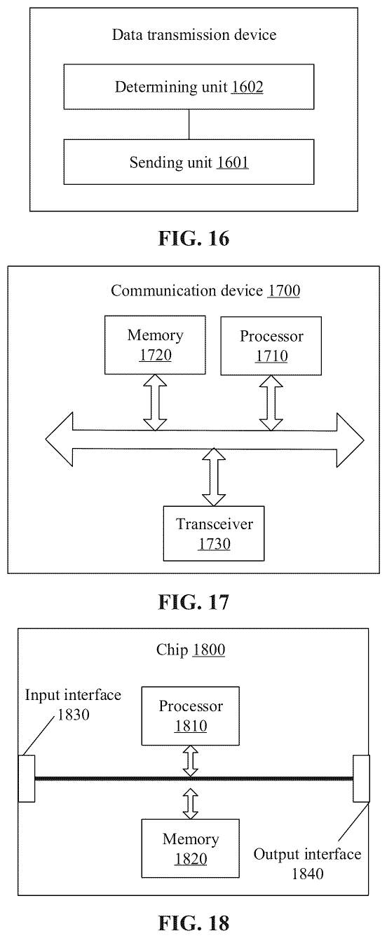

FIG. 16 is a fifth schematic structural diagram of a data transmission device according to an embodiment of the present disclosure. The data transmission device shown in FIG. 16 is applied to the second node. As shown in FIG. 16, the data transmission device includes a sending unit 1601.

The sending unit 1601 is configured to send a data recovery indication to a first node, where the data recovery indication is used for triggering a PDCP layer of the first node to perform data recovery on partial data.

In some optional implementations, the data recovery indication includes at least one of following information associated with the partial data: a DRB ID, a GOP ID list, a PDU set ID list, or a frame type.

In some optional implementations, the trigger condition for sending the data recovery indication includes at least one of:
an Intra-Centralized Unit Handover (Intra-CU HO) occurs;
RLC release and add is performed based on an RRC configuration;
RLC reestablishment is performed by an RLC entity;
bearer type change is performed based on the RRC configuration; or
a PDCP layer of the second node determines that the trigger condition is satisfied.

In some optional implementations, the device further includes a determining unit 1602 configured to: start a first timer after sending the data recovery indication through the PDCP layer, and set a most recently received PDCP SN as a first recovery PDCP SN; and determine that the trigger condition is satisfied if a PDCP SN that is not received by the PDCP layer of the second node exists within a first PDCP SN range when the first timer expires. The first PDCP SN range includes the first recovery PDCP SN and a PDCP SN prior to the first recovery PDCP SN; or the first PDCP SN range includes a PDCP SN between the first recovery PDCP SN and a second recovery PDCP SN. The second recovery PDCP SN is a corresponding recovery PDCP SN when the first timer was last started.

In some optional implementations, the device further includes a determining unit 1602 configured to: start a second timer through the PDCP layer if a PDCP SN that is not received by the PDCP layer of the second node exists; determine that the trigger condition is satisfied if the PDCP SN that is not received by the PDCP layer of the second node still exists when the second timer expires.

In some optional implementations, the device further includes a determining unit 1602 configured to determine that the trigger condition is satisfied if a PDCP SN that is not received by the PDCP layer of the second node exists.

In some optional implementations, the device further includes a determining unit 1602 configured to determine that the trigger condition is satisfied if a PDCP SN that is not received by the PDCP layer of the second node exists and data corresponding to the PDCP SN that is not received belongs to data corresponding to a first frame type.

In some optional implementations, the data recovery indication is carried in the MAC CE or the DCI.

Those skilled in the art will appreciate that the above-described description of the data transmission device in the embodiment of the present disclosure may be understood with reference to the description of the data transmission method in the embodiment of the present disclosure.

FIG. 17 is a schematic structural diagram of a communication device 1700 according to an embodiment of the present disclosure. The communication device may be a terminal device or a network device. The communication device 1700 shown in FIG. 17 includes a processor 1710, and the processor 1710 may invoke and execute a computer program from a memory to implement the methods in the embodiments of the present disclosure.

Optionally, as shown in FIG. 17, the communication device 1700 may further include a memory 1720. The processor 1710 may invoke and execute the computer program from the memory 1720 to implement the methods in the embodiments of the present disclosure.

The memory 1720 may be a separate device independent of the processor 1710 or the memory 1720 may be integrated into the processor 1510.

Optionally, as shown in FIG. 17, the communication device 1700 may further include a transceiver 1730. The processor 1710 may control the transceiver 1730 to communicate with other devices, in particular, to send information or data to other devices, or receive information or data sent by other devices.

The transceiver 1730 may include a transmitter and a receiver. The transceiver 1730 may further include an antenna(s), the number of which may be one or more.

Optionally, the communication device 1700 may be specifically a network device in the embodiments of the present disclosure, and the communication device 1700 may implement the corresponding process implemented by the network device in each method of the embodiments of the present disclosure, which will not be elaborated herein for simplicity.

Optionally, the communication device 1700 may be a mobile terminal/terminal device according to the embodiments of the present disclosure, and the communication device 1700 may implement the corresponding flows implemented by the mobile terminal/terminal device in each method of the embodiments of the present disclosure, which will not be elaborated herein for simplicity.

FIG. 18 is a schematic structural diagram of a chip according to an embodiment of the present disclosure. The chip 1800 shown in FIG. 18 includes a processor 1810 that may invoke and execute a computer program from a memory to implement the methods in the embodiments of the present disclosure.

Optionally, as shown in FIG. 18, the chip 1800 may also include a memory 1820. The processor 1810 may invoke and execute a computer program from the memory 1820 to implement the methods in the embodiments of the present disclosure.

The memory 1820 may be a separate device independent of the processor 1810 or may be integrated in the processor 1810.

Optionally, the chip 1800 may also include an input interface 1830. The processor 1810 may control the input interface 1830 to communicate with other devices or chips, and in particular may obtain information or data sent by other devices or chips.

Optionally, the chip 1800 may also include an output interface 1840. The processor 1810 may control the output interface 1840 to communicate with other devices or chips, and in particular may output information or data to other devices or chips.

Optionally, the chip may be applied to the network device in the embodiments of the present disclosure, and the chip may implement the corresponding flows implemented by the network device in each method of the embodiments of the disclosure, which will not be elaborated herein for simplicity.

Optionally, the chip may be applied to the mobile terminal/terminal device in the embodiments of the present disclosure, and the chip may implement the corresponding flows implemented by the mobile terminal/terminal device in each method of the embodiment of the disclosure, which will not be elaborated herein for simplicity.

It is to be understood that chips mentioned in the embodiments of the present disclosure may also be referred to as system level chips, system chips, chip systems or on-chip system chips, etc.

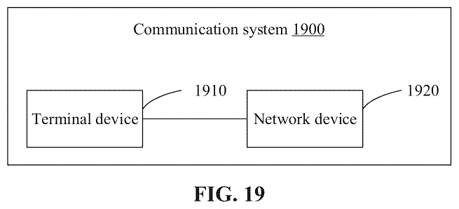

FIG. 19 is a schematic block diagram of a communication system 1900 according to an embodiment of the present disclosure. As shown in FIG. 19, the communication system 1900 includes a terminal device 1910 and a network device 1920.

Herein, the terminal device 1910 may be configured to implement the corresponding functions implemented by the terminal device in the above-described methods, and the network device 1920 may be configured to implement the corresponding functions implemented by the network device in the above-described methods, which will not be elaborated herein for simplicity.

It is to be understood that the processor of the embodiments of the disclosure may be an integrated circuit chip with signal processing capacity. In an implementation process, various steps of the above method embodiments may be completed by an integrated logic circuit of hardware in the processor or an instruction in the form of software. The above processor may be a general-purpose processor, a Digital Signal Processor (DSP), an Application Specific Integrated Circuit (ASIC), a Field Programmable Gate Array (FPGA), or other programmable logic devices, discrete gate or transistor logic devices, and discrete hardware components. Various methods, steps, and logical block diagrams disclosed in the embodiments of the disclosure may be implemented or performed. The general-purpose processor may be a microprocessor, any conventional processor, or the like. Steps of the methods disclosed with reference to the embodiments of the disclosure may be directly performed and accomplished by a hardware decoding processor, or may be performed and accomplished by a combination of hardware and software modules in the decoding processor. The software module may be located in a storage medium mature in the art, such as a random access memory, a flash memory, a read-only memory, a programmable read-only memory or electrically erasable programmable memory, or a register. The storage medium is located in the memory, and the processor reads information in the memory and completes the steps in the foregoing methods in combination with hardware of the processor.

It may be understood that the memory in the embodiments of the disclosure may be a volatile memory or a nonvolatile memory, or may include a volatile memory and a nonvolatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a RAM, which is used as an external high-speed cache. By way of example but not restrictive description, many forms of RAMs may be used, for example, a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM), and a Direct Rambus RAM (DR RAM). It is to be noted that the memory of the systems and methods described in this specification includes but is not limited to these and any other proper types of memories.

It is to be understood that the abovementioned memories are exemplary but not restrictive, for example, the memory in the embodiments of the disclosure may also be a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), and a Direct Rambus RAM (DR RAM). That is to say, the memories described in the embodiment of the disclosure are intended to include, but not limited to, these and any other suitable types of memories.

The embodiments of the disclosure further provide a computer-readable storage medium, which is configured to store a computer program.

Optionally, the computer-readable storage medium may be applied to the network device in the embodiments of the disclosure. The computer program enables a computer to execute corresponding flows implemented by the network device in each method of the embodiments of the disclosure, which will not be elaborated here for simplicity.

Optionally, the computer-readable storage medium may be applied to the mobile terminal/terminal device in the embodiments of the disclosure. The computer program enables a computer to execute corresponding flows implemented by the mobile terminal/terminal device in each method of the embodiments of the disclosure, which will not be elaborated here for simplicity.

The embodiments of the disclosure further provide a computer program product, which includes a computer program instruction.

Optionally, the computer program product may be applied to a network device in the embodiments of the disclosure. The computer program instruction enables a computer to execute corresponding flows implemented by the network device in each method of the embodiments of the disclosure, which will not be elaborated here for simplicity.

Optionally, the computer program product may be applied to the mobile terminal/terminal device in the embodiments of the disclosure. The computer program instruction enables a computer to execute corresponding flows implemented by the mobile terminal/terminal device in each method of the embodiments of the disclosure, which will not be elaborated herein for simplicity.

The embodiments of the disclosure further provide a computer program.

Optionally, the computer program may be applied to the network device in the embodiments of the disclosure. The computer program runs in a computer to enable the computer to execute corresponding flows implemented by the network device in each method of the embodiments of the disclosure, which will not be elaborated herein for simplicity.

Optionally, the computer program may be applied to the mobile terminal/terminal device in the embodiments of the disclosure. When running on a computer, the computer program enables a computer to execute corresponding flows implemented by the mobile terminal/terminal device in each method of the embodiments of the disclosure, which will not be elaborated here for simplicity.

Those of ordinary skill in the art may be aware that the units and algorithm steps in the examples described with reference to the embodiments disclosed in this specification can be implemented by electronic hardware or a combination of computer software and electronic hardware. Whether the functions are performed by hardware or software depends on particular applications and design constraints of the technical schemes. A person skilled in the art may realize the described functions for each particular disclosure by different methods, but it is not considered that the implementation is beyond the scope of the disclosure.

It may be clearly understood by a person skilled in the art that, for the purpose of convenient and brief description, for a detailed working process of the foregoing system, apparatus, and unit, reference may be made to a corresponding process in the foregoing method embodiments, and details are not described again herein.

In the several embodiments provided in the disclosure, it is to be understood that the disclosed system, apparatus, and method may be implemented in other modes. For example, the apparatus embodiment described above is only schematic, and for example, division of the units is only logic function division, and other division manners may be adopted during practical implementation. For example, multiple units or components may be combined or integrated into another system, or some characteristics may be neglected or not executed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate components may or may not be physically separated, and the components displayed as units may or may not be physical units, and may be located in one place or may be distributed over multiple network units. Some or all of the units may be selected according to actual needs to achieve the objectives of the solutions of the embodiments.

In addition, functional units in various embodiments of the disclosure may be integrated into one processing unit, or each of the units may be physically separated, or two or more units may be integrated into one unit.

When the functions are realized in a form of a software functional unit and sold or used as an independent product, they may be stored in a computer-readable storage medium. In view of this understanding, the technical schemes of the embodiments of the disclosure essentially or the parts that contribute to the prior art, or part of the technical schemes can be embodied in the form of a software product. The computer software product is stored in a storage medium, including multiple instructions for causing a computer device (which may be a personal computer, a server, or a network device, and the like) to execute all or part of the steps of the method described in the embodiments of the disclosure. The foregoing storage medium includes a USB flash disk, a mobile hard disk drive, an ROM, an RAM, and various media that can store program codes, such as a magnetic disk or an optical disk.

The above description is merely specific implementations of the disclosure, but is not intended to limit the scope of protection of the disclosure. Any variation or replacement readily figured out by a person skilled in the art within the technical scope disclosed in the disclosure shall fall within the scope of protection of the disclosure. Therefore, the scope of protection of the disclosure is defined by the scope of protection of the claims.

1. A data transmission method, comprising:
receiving, by a Packet Data Convergence Protocol (PDCP) layer, a first Service Data Adaptation Protocol (SDAP) Packet Data Unit (PDU) sent by a SDAP layer, the first SDAP PDU being a downlink SDAP control PDU, wherein the downlink SDAP control PDU comprises at least one of following information:
first information for indicating whether the first SDAP PDU is a data PDU or a control PDU;
second information for indicating a Quality of Service (Qos) flow Identifier (ID) associated with the first SDAP PDU;
third information for indicating a control PDU type to which the first SDAP PDU belongs;
fourth information for indicating a frame type corresponding to a PDU set or a frame associated with the first SDAP PDU;
fifth information for indicating a Qos attribute of the PDU set, the frame or a PDU associated with the first SDAP PDU;
sixth information for indicating an ID of the PDU set or the frame associated with the first SDAP PDU;
seventh information for indicating an ID of a Group of Pictures (GOP) to which the PDU set or the frame associated with the first SDAP PDU belongs; or
eighth information for indicating IDs of at least part of PDUs in the PDU set associated with the first SDAP PDU.

2. The method of claim 1, further comprising:
identifying, by the PDCP layer based on the downlink SDAP control PDU, SDAP PDUs or SDAP Service Data Units (SDUs) having an association relationship, wherein the association relationship means belonging to a same PDU set or a same frame.

3. The method of claim 1, further comprising:
receiving, by the PDCP layer, a second SDAP PDU sent by the SDAP layer, the second SDAP PDU being a downlink SDAP data PDU, wherein the downlink SDAP data PDU in a first format comprises first information for indicating whether the second SDAP PDU is a data PDU or a control PDU.

4. The method of claim 3, wherein the PDCP layer and the SDAP layer are protocol layers of a network device; and the method further comprises:
determining, by the network device, whether a format of the downlink SDAP data PDU is a first format or a second format.

5. The method of claim 4, wherein determining, by the network device, whether the format of the downlink SDAP data PDU is the first format or the second format comprises:
if the network device receives first capability information reported by a terminal device, determining, by the network device, that the format of the downlink SDAP data PDU is the first format; and
if the network device does not receive the first capability information reported by the terminal device, determining, by the network device, that the format of the downlink SDAP data PDU is the second format,
wherein the first capability information is used for indicating that the terminal device supports the downlink SDAP data PDU in the first format.

6. The method of claim 4, wherein determining, by the network device, whether the format of the downlink SDAP data PDU is the first format or the second format comprises:
receiving, by the network device, second capability information reported by a terminal device;
if the second capability information indicates that the terminal device supports a first capability, determining, by the network device, that the format of the downlink SDAP data PDU is the first format; and
if the second capability information indicates that the terminal device does not support the first capability, determining, by the network device, that the format of the downlink SDAP data PDU is the second format,
wherein the first capability is a capability that the terminal device supports the downlink SDAP data PDU in the first format, or the first capability is a capability that the terminal device supports a first protocol version.

7. A data transmission method, comprising:
receiving, by a terminal device, a second Service Data Adaptation Protocol (SDAP) Packet Data Unit (PDU) sent by a network device, the second SDAP PDU being a downlink SDAP data PDU, wherein the downlink SDAP data PDU in a first format comprises first information for indicating whether the second SDAP PDU is a data PDU or a control PDU.

8. The method of claim 7, further comprising:
receiving, by the terminal device, first indication information sent by the network device, wherein the first indication information is used for indicating whether the first format or a second format is to be used by the terminal device as a format of the downlink SDAP data PDU; and
determining, by the terminal device, the format of the downlink SDAP data PDU based on the first indication information.

9. The method of claim 8, wherein the first indication information is configured per Qos flow, configured per DRB, configured per PDU session, or configured per User Equipment (UE).

10. The method of claim 7, further comprising:
if the terminal device reports first capability information to the network device, determining, by the terminal device and the network device, that the format of the downlink SDAP data PDU is the first format; and
if the terminal device does not report the first capability information to the network device, determining, by the terminal device and the network device, that the format of the downlink SDAP data PDU is the second format,
wherein the first capability information is used for indicating that the terminal device supports the downlink SDAP data PDU in the first format.

11. The method of claim 7, further comprising:
reporting, by the terminal device, second capability information to the network device;
if the second capability information indicates that the terminal device supports a first capability, determining, by the terminal device and the network device, that the format of the downlink SDAP data PDU is the first format; and
if the second capability information indicates that the terminal device does not support the first capability, determining, by the terminal device and the network device, that the format of the downlink SDAP data PDU is the second format,
wherein the first capability is a capability that the terminal device supports the downlink SDAP data PDU in the first format; or, the first capability is a capability that the terminal device supports a first protocol version.

12. A data transmission device, comprising: a processor and a memory, wherein the memory is configured to store computer-executable instructions, and the processor is configured to invoke and execute the computer-executable instructions stored in the memory to perform an operation of:
receiving, by a Packet Data Convergence Protocol (PDCP) layer, a first Service Data Adaptation Protocol (SDAP) Packet Data Unit (PDU) sent by a SDAP layer, the first SDAP PDU being a downlink SDAP control PDU, wherein the downlink SDAP control PDU comprises at least one of following information:
first information for indicating whether the first SDAP PDU is a data PDU or a control PDU;
second information for indicating a Quality of Service (Qos) flow Identifier (ID) associated with the first SDAP PDU;
third information for indicating a control PDU type to which the first SDAP PDU belongs;
fourth information for indicating a frame type corresponding to a PDU set or a frame associated with the first SDAP PDU;
fifth information for indicating a Qos attribute of the PDU set, the frame or a PDU associated with the first SDAP PDU;
sixth information for indicating an ID of the PDU set or the frame associated with the first SDAP PDU;
seventh information for indicating an ID of a Group of Pictures (GOP) to which the PDU set or the frame associated with the first SDAP PDU belongs; or
eighth information for indicating IDs of at least part of PDUs in the PDU set associated with the first SDAP PDU.

13. The data transmission device of claim 12, wherein the processor is configured to invoke and execute the computer-executable instructions stored in the memory to further perform an operation of:
identifying, by the PDCP layer based on the downlink SDAP control PDU, SDAP PDUS or SDAP Service Data Units (SDUs) having an association relationship, wherein the association relationship means belonging to a same PDU set or a same frame.

14. The data transmission device of claim 12, wherein the processor is configured to invoke and execute the computer-executable instructions stored in the memory to further perform an operation of:
receiving, by the PDCP layer, a second SDAP PDU sent by the SDAP layer, the second SDAP PDU being a downlink SDAP data PDU, wherein the downlink SDAP data PDU in a first format comprises first information for indicating whether the second SDAP PDU is a data PDU or a control PDU.

15. The data transmission device of claim 14, wherein the PDCP layer and the SDAP layer are protocol layers of a network device; and the processor is configured to invoke and execute the computer-executable instructions stored in the memory to further perform an operation of:
determining, by the network device, whether a format of the downlink SDAP data PDU is a first format or a second format.

16. The data transmission device of claim 15, wherein determining, by the network device, whether the format of the downlink SDAP data PDU is the first format or the second format comprises:
if the network device receives first capability information reported by a terminal device, determining, by the network device, that the format of the downlink SDAP data PDU is the first format; and
if the network device does not receive the first capability information reported by the terminal device, determining, by the network device, that the format of the downlink SDAP data PDU is the second format,
wherein the first capability information is used for indicating that the terminal device supports the downlink SDAP data PDU in the first format.

17. The data transmission device of claim 15, wherein determining, by the network device, whether the format of the downlink SDAP data PDU is the first format or the second format comprises:
receiving, by the network device, second capability information reported by a terminal device;
if the second capability information indicates that the terminal device supports a first capability, determining, by the network device, that the format of the downlink SDAP data PDU is the first format; and
if the second capability information indicates that the terminal device does not support the first capability, determining, by the network device, that the format of the downlink SDAP data PDU is the second format,
wherein the first capability is a capability that the terminal device supports the downlink SDAP data PDU in the first format, or the first capability is a capability that the terminal device supports a first protocol version.

18. A communication device comprising: a processor and a memory, wherein the memory is configured to store computer-executable instructions, and the processor is configured to invoke and execute the computer-executable instructions stored in the memory to perform the method of claim 7.

19. A non-transitory computer-readable storage medium having stored thereon computer-executable instructions which, when executed by a processor, causes a processor to perform the method of claim 1.

20. A non-transitory computer-readable storage medium having stored thereon computer-executable instructions which, when executed by a processor, causes a processor to perform the method of claim 7.
